(19) United States
(12) Patent Application Publication
(10) Pub. No.: US 2014/0343970 A1
(43) Pub. Date: Nov. 20, 2014

(54) Real Estate Transaction Management Processes

(71) Applicant: Mark Weber, Reno, NV (US)

(72) Inventor: Mark Weber, Reno, NV (US)

(21) Appl. No.: 14/338,017

(22) Filed: Jul. 22, 2014

Related U.S. Application Data
(63) Continuation-in-part of application No. 13/950,217, filed on Jul. 24, 2013.
(60) Provisional application No. 61/675,210, filed on Jul. 24, 2012.

(51) Int. Cl. G06Q 40/08; G06Q 50/16

(52) U.S. Cl. CPC G06Q 40/08; G06Q 50/16
USPC 705/4; 705/313

(57) ABSTRACT

A real estate transaction management process. A developer and a transaction institution enter into an agreement for the developer to purchase a pool of real estate assets at a price above market value. The pool has REO parcels and delinquent loans, each loan secured by a mortgage encumbering a parcel. Pursuant to the agreement the developer obtains some or all of the encumbered parcels by foreclosure, consent sales, and short sales, renovates some of the REO and obtained parcels, leases some of them and pays part of the rent to the transaction institution, and sells some of them and pays part of the sales revenue to the transaction institution.

### CROSS-REFERENCE TO RELATED APPLICATIONS

The present nonprovisional application is a Continuation-In-Part of applicant's prior U.S. nonprovisional patent application entitled “Real Estate Transaction Process,” Ser. No. 13/950,217, filed Jul. 24, 2013, which claims priority through the applicant's prior U.S. provisional patent application, entitled “Real Estate Portfolio Insurance,” Ser. No. 61/675,210, filed Jul. 24, 2012, which prior patent applications are hereby incorporated by reference in their entirety. In the event of any inconsistency between such prior patent applications and the present nonprovisional application (including without limitation any limiting aspects), the present nonprovisional application shall prevail.

### FIELD

This application relates to real estate transaction management processes, and more particularly to bulk sale real estate transaction management processes.

### APPLICANT′S VIEW OF ASPECTS OF PRIOR SYSTEMS

Home real estate loan institutions, for example banks and government-sponsored entities (GSEs) such as Fannie Mae and Freddie Mac, have long been burdened by large numbers of non-performing housing loans (mortgages). Through foreclosures, these institutions have also acquired many unproductive parcels of real estate. Such a parcel is referred to as an REO—real estate owned by the institution.

Estimates of the magnitude of this problem—numbers of REOs and non-performing loans—range as high as ten million housing units in the United States. The U.S. Census Bureau estimates that seven million such units are being kept off the market. For a variety of reasons, these properties are often not only unoccupied but also in poor condition—significantly worse than would typically be the case in a stable or growing housing market.

This situation has caused serious problems for these institutions. There are currently few options for selling these REOs and non-performing loans in bulk at reasonable values, especially at values even close to values at which the properties are carried on the books. Foreclosures followed by individual parcel sales are expensive, time consuming, and oftentimes recover not only less than book value but often less than the amount of the loan. These sales also depress the values of surrounding properties in an already-depressed housing market. The result has been an untenable situation in which vacant properties are held off the market for long periods of time. It has also led to entire neighborhoods or regional areas having a large number of unoccupied and poorly-maintained houses.

Large-scale sales of distressed single-family homes have been very rare. Instead, real estate loan institutions have typically have sold small numbers of properties through auctions and brokers and foreclosed on mortgages in a cautious manner. As a result, most large banks and GSEs have substantial numbers of REOs worth less than book value and delinquent (and often under-water) mortgages to address. In turn, equity markets have valued the capital of some of these institutions at less than their stated book values, driving the cost of capital past the level of the institutions' asset returns and earnings.

Relatively recently, there have been some improvements in housing values in some regions. The Applicant believes that much of this improvement is due to artificially low interest rates and to the fact that few homes are on the market since many sellers are requiring prices to rise substantially before they will agree to sell.

Another complication of the current real estate banking crises is that banks have been utilizing short sales to obtain properties from borrowers who are delinquent or seriously under water. In a short sale, the borrower sells the property to a new buyer for less than the amount owed on the mortgage. The lending institution is a party to the transaction and agrees to accept the purchase price in payment of the loan, thereby sustaining a loss.

A short sale negatively impacts the credit rating of the borrower almost as badly as a foreclosure. Thus, many borrowers avoid short sales, depriving the lender of the opportunity to procure at least some value for the loan without having to resort to foreclosure. Moreover, short sales often reduce the value of other properties in the neighborhood.

### BRIEF SUMMARY OF SOME ASPECTS OF THIS APPLICATION

The applicant has invented real estate transaction management processes having a number of novel aspects and features. In one aspect, a lender such as a bank or GSE retains some of its real estate loans and/or REOs on its books at values higher, and in some instances substantially higher, than current market values. In some instances the lender can sell many such assets to a bulk real estate acquirer such as an investor or a developer (the acquirer may be a single entity or multiple entities acting together) at reasonable values substantially higher than current market values, in some cases 20% or 40% higher and in other cases as much as 70% or more above current market values. The lender can also keep others of such assets on its books with the acquirer providing services that ultimately result in sales at prices substantially above the current market.

In some instances, a lender may assign to an acquirer conditional or limited rights in a large number of REOs or non-performing mortgages or both. In exchange for such rights, the acquirer may promise to renovate the REOs and/or mortgaged properties and provide the lender with cash flow or other assets over a time sufficient for the lender to sell the REOs and mortgages at values above, and in some embodiments well above, actual market values at the time the acquirer enters into the transaction.

For example, in some systems the acquirer can guarantee:

(1) renovation and leasing of at least a substantial percentage of the REOs and mortgaged properties over a period of time;

(2) payments to the lender from revenue generated by leasing REOs and mortgaged properties; and

(3) payment to the lender of an agreed portion of revenue or other assets arising from sales by the acquirer of any of the REOs and mortgaged properties. The period of time to sale can be fixed or variable. The lender may have a right to specify that given properties be sold at certain times that may be sooner or later than planned by the acquirer.

In certain instances the acquirer may obtain a large portfolio of REOs from a lender, take responsibility for renovating and leasing them to third parties, and guarantee a stream of payments to the lender over time, including one or more of down payments, monthly payments, and final payments. The payment stream may have a GAAP-compliant value based upon the present value of the payments. To provide protection for the lender, some process may provide that an agreed portion of the revenue is backed up by, or actually paid by, a third-party guarantor or insurer. The period of time to sale may be determined by agreement between the lender and the acquirer, and in some instances the time-to-sale can be altered if there are material changes in the market such as substantial increases in the market values of properties.

In some embodiments, the acquirer can provide the lender with a form of guarantee of at least a portion of the stream of payments, providing increased net present value for the REOs and mortgages. For example, the guarantee can be for the final payment backstopped by a minimum sale value. In some applications, such final payment can be supported by put options or other derivatives (based upon either the specific portfolio or the markets in which they reside, depending on the preference of the lender) or by third-party insurance insuring against any fall in value of the property below the amount of the final payment. In some embodiments the monthly payments can be guaranteed by (i) minimum cash balances maintained by the acquirer and based on an actuarial formula or (ii) a captive insurance plan covering the entire duration of the monthly payments, in some instances backstopped by a third-party reinsurer.

In some embodiments, the lender may insure a minimum value of the properties through an insurance policy for which the minimum value may be equal to the current value, or the actual dollar amount, of the non-performing loan in the case of mortgages, or the original value or actual dollar amount of the original mortgage in the case of REOs.

In some instances, some or all such insurance may be provided by the lender itself. Or, such property-value-guarantee insurance can be provided by another entity, yielding a new form of insurance and method of generating revenue as a result of bulk real estate transactions with the lender.

Another aspect can include the acquirer securing interest rates at the time of the bulk acquisition at rates that are lower than projected to exist in the future when the acquirer renovates, leases, and sells the properties. This may have an impact on the present value of the stream of payments and in some instances can allow for the immediate or at least earlier sale of non-performing mortgages, even non-performing mortgages that have been delinquent for a long time.

In some embodiments, such lower interest rates can be guaranteed or arranged by the lender. This can be accomplished by using privately-negotiated derivatives comparable to, or including, interest rate swaps to lock in a cost of capital for insurance policy payments. For example, if such payments are to extend over ten years, costs of capital can be locked in for each of those years, with such costs used to discount future payments in calculating value.

Another aspect involves amortizing the cost of capital of the transaction over the applicable period for cost of capital related to similar loans. For example, if such cost for the lender at the time of the transaction is 50 basis points (bps), an estimate can be made of the cost of capital for each of the next nine years. This can be done with a GAAP-compliant procedure that may optimize such cost of capital. Such estimates can be used in discounting payments. While such a discount may be lower and have less up-front cost, the lender may discount the value of applicable properties in the future to the extent interest rates rise faster than anticipated.

In yet another aspect, the acquirer may replicate one or more of the processes or features with one or more other lenders. Similarly, in some embodiments yet other acquirers may engage in similar transactions with yet other acquirers.

A still further aspect is that the acquirer can renovate, lease, or sell the acquired properties. Upon sale of a property and payment of the agreed portion of the proceeds to the lender, that institution will have received revenue in exchange for the previously distressed property. In some embodiments this revenue may be more, and in certain instances much more, than the market value of the property at the time the acquirer acquired the property.

In certain applications, the can acquirer commit to (and then does) renovate the acquired properties over a certain period of time, lease the acquired properties for an agreed number of years (for example, five to ten years), and sell the properties by an agreed time. In some embodiments, during the time this process is taking place, the acquirer can provide one or more of down payments, monthly or other payments, and final payments to the lender. The acquirer may agree to acquire properties at any cap rate and in any condition. Cap rate can be determined as net rental income divided by value of the property, either current market value, or market value at the time the acquirer obtained the property, or value of consideration the acquirer gave the lender for the property.

In some instances, real estate transaction management processes of the kind disclosed herein can stabilize and even dramatically improve real estate markets locally, regionally, and even nationally. Lenders can use these processes to improve their balance sheets by selling low-market-value properties to acquirers for a stream of payments with a net present value materially above the low market values. An acquirer can provide or procure investment to renovate the properties, provide other payments, or sell the properties expeditiously if this becomes a desirable option. Other real estate owners and investors can observe the process as it unfolds and more reliably maintain or acquire nearby properties. The result can be increased housing values not just for the properties subject to the process but also for many other properties affected by the process.

There are other novel and advantageous aspects of this Specification. They become apparent as this Specification proceeds. In this regard, the scope of the invention is to be determined by the claims as issued and not by whether a given claims solves one or more problems, addresses one or more issues, or provides one or more features noted in the Applicant's Views above or this Brief Summary.

### BRIEF DESCRIPTION OF THE DRAWINGS

The applicant's preferred and other embodiments are disclosed in association with the accompanying drawings in which:

FIG. 1 is a flowchart illustrating an embodiment of a real estate transaction management process;

FIG. 2 is a flowchart illustrating another embodiment of a real estate transaction management process;

FIG. 3 is a flowchart illustrating another embodiment of a real estate transaction management process;

FIG. 4 is a flowchart illustrating another embodiment of a real estate transaction management process;

FIG. 5 is a spreadsheet showing projected cash flow to the bank (also referred to as the seller, the lender, and the transaction institution) and to the developer (also referred to as the acquirer) over a ten-year period for a typical REO in Example One of a real estate transaction process as summarized in Tables 1-5;

FIG. 6 is a spreadsheet of the developer's projected income and tax statement in Example One;

FIG. 7 is a spreadsheet giving the developer's projected assets and liabilities in Example One;

FIG. 8 is a spreadsheet giving capital repayments by the developer to the bank and to an external financer in Example One;

FIG. 9 is a spreadsheet giving property value and depreciation of the parcel in Example One;

FIG. 10 is a spreadsheet of projected cash interest earnings in Example One;

FIG. 11 is a spreadsheet giving a financial projection of project cash flow for the developer and the bank based on information in Table 6 in Example One;

FIG. 12 is a spreadsheet giving a financial projection of project cash flow for the developer and the bank based on information in Table 6 with payments to bank delayed for two years as in Example One;

FIGS. 13-19 are spreadsheets that are similar to FIGS. 5-11, respectively, but comprising data illustrating Example Two;

FIGS. 20-27 are spreadsheets that are similar to FIGS. 5-12, respectively, but comprising data illustrating Example Three;

FIGS. 28-35 are spreadsheets that are similar to FIGS. 5-12, respectively, but comprising data illustrating Example Four;

FIGS. 36-38 are spreadsheets that are similar to FIGS. 5-7, respectively, but comprising data illustrating Example Five;

FIG. 39 is a spreadsheet giving a senior schedule in Example Five; and

FIGS. 40 and 41 are spreadsheets that are similar to FIGS. 9 and 10, respectively, but comprising data illustrating Example Five.

### DETAILED DESCRIPTION

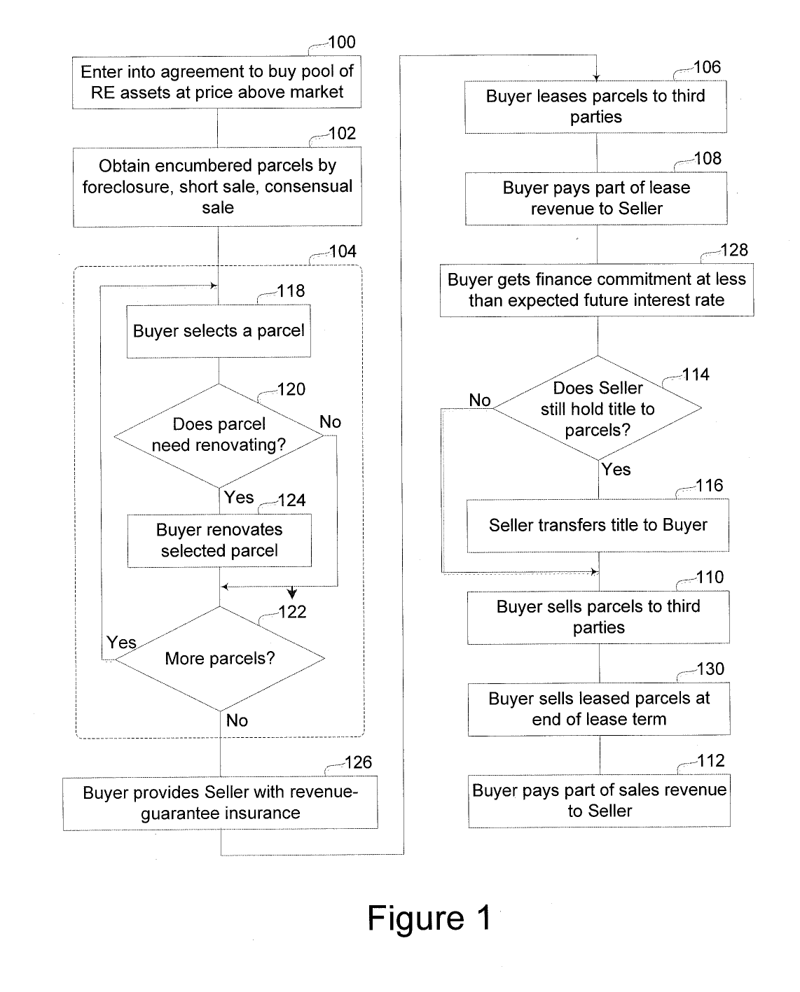

Referring to FIG. 1, in one aspect a real estate transaction management process includes an acquirer entering into a transfer agreement (100) with a transaction institution to purchase a pool of real estate assets at a price above market value. The pool includes institution-owned parcels (REOs) and a plurality of delinquent loans. Each loan is secured by a mortgage encumbering a parcel. Pursuant to the transfer agreement: the acquirer: (i) obtains a plurality of the encumbered parcels by one or more of foreclosure, consent sales, and short sales (102); (ii) renovates a number of the REO parcels and the obtained parcels (104); (iii) leases a number of the REO parcels and the obtained parcels to one or more third parties (106); (iv) pays the institution a portion of revenue generated by leasing (108); (v) sells a number of the REO parcels and the obtained parcels to one or more third parties(110); and (vi) pays the institution a portion of revenue generated by such sales (112).

In this Specification, The term “renovation” as used herein means most any kind of work on a parcel that alters, improves, or physically transforms some aspect of the physical condition of the parcel. Renovations may include without limitation one or more of the following:

repair to damaged landscaping such as dying or dead plants;

landscape installation, repair, and maintenance;

painting the exterior or interior of a house or associated garage;

repairing plumbing or electrical structures;

repairing or installing flooring, such as tile, carpet, and wood planks;

repairing or installing damaged doors, windows, and screens;

repairing or installing appliances;

repairing or installing bathroom fixtures;

repairing or installing walls, cabinetry, and the like; and

making any other physical repairs or upgrades to the property.

Throughout this description an “acquirer” may be an individual or an entity, or a group of individuals or entities or both, such as developers and investors, interested in acquiring pools of real estate assets. In this description and in the drawings the terms “acquirer”, “buyer”, and “developer” may be used interchangeably to refer to any such person or entity.

Similarly, the transaction institution may be one or more individuals or entities or both, such as banks and GEOs, that have, and wish to sell, pools of real estate assets. The terms “lender”, “bank”, “seller”, “institution”, and “transaction institution” may be used interchangeably to refer to any such person or entity.

Referring again to FIG. 1, in some instances the transaction institution retains legal title to a plurality of the assets in the pool after entering into the transfer agreement (114) and subsequently transfers title to the acquirer (116) not later than any sale to a third party. Or the institution may transfer the title directly to the third party at the time of a sale.

In some instances the renovation proceeds on a parcel-by-parcel basis with the acquirer selecting a parcel (118), determining whether the parcel needs renovation (120), and if so performing the renovation (122)′; if there are more parcels to be considered, repeat the process (124). The term “renovation” may include but is not necessarily limited to one or more of maintaining landscaping; painting exterior or interior surface; and repairing or replacing one or more of landscaping, plumbing, plumbing fixtures, electrical wiring, electrical fixtures, flooring, windows, doors, and appliances.

Some instances include providing insurance for the benefit of the transaction institution guaranteeing payment of a portion of the revenue due the transaction institution (126). This insurance may be provided by the acquirer directly or through a third party insurer, or the transaction institution may obtain such insurance.

Some processes include obtaining a financing commitment at an interest rate lower than a predetermined future interest rate for loans to finance the sales of the REO and obtained parcels (128). This commitment may be obtained by the acquirer from one or more third parties, or the transaction institution may provide part or all of such a commitment.

In some instances, the acquirer leases one or more parcels to third-party tenants. The acquirer may sell such leased parcels at the end of the lease term (130).

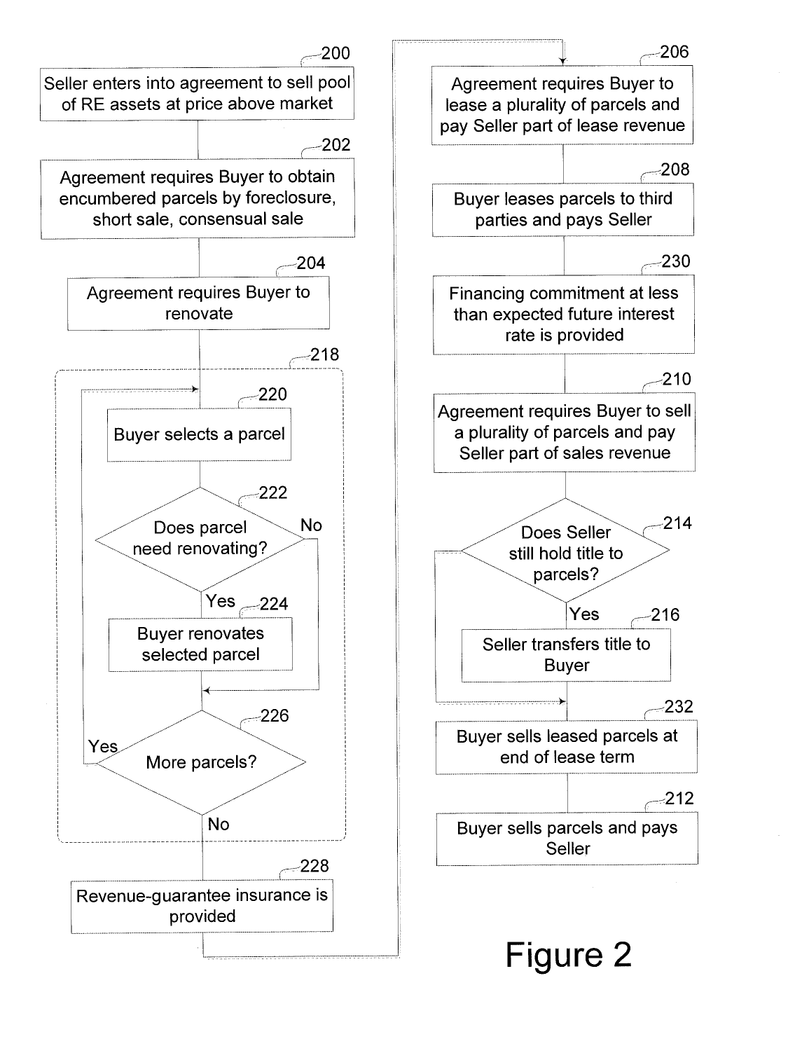

FIG. 2 shows an embodiment of a real estate management process in which a transaction institution enters into a transfer agreement with a developer or other acquirer to sell a pool of real estate assets to the developer at a price above market value (200). The pool includes a plurality of REO parcels and a plurality of delinquent loans, and each loan is secured by a mortgage encumbering a parcel. Pursuant to the transfer agreement: developer agrees to obtain a plurality of the encumbered parcels by one or more of foreclosure, consensual sales, and short sales (202). renovate a plurality of the REO and obtained parcels (204); lease a plurality of the REO and obtained parcels to one or more third parties (206); sell a plurality of the REO and obtained parcels to one or more third parties (210); and provide to the transaction institution a portion of the leasing revenue (208) from the leasing (206) and a portion of sales revenue (212) from the sales (210).

In some instances the transaction institution retains legal title to a plurality of the assets in the pool after entering into the transfer agreement until a time not later than any sale to a third party (214). At that time, the institution transfers title to the acquirer (216) or in some instances direct to a third-party purchaser.

In some instances, renovation (generally 218) proceeds on a parcel-by-parcel basis with the acquirer selecting a parcel (220), determining whether the parcel should be renovated (222) and if so performing the renovation (224); if there are more parcels to be considered, the process is repeated (226).

Some methods include providing insurance, guaranteeing payment of the portion of (or a differing amount) the leasing and selling revenue to be received (228). This may be done by or through the transaction institution or the acquirer or a third party.

Some instances include providing a financing commitment at an interest rate lower than a predetermined future interest rate for loans to finance sales of the REO and obtained parcels (230). This commitment may be provided by the transaction institution, or it may be obtained by the acquirer or a third party lender.

Leasing a parcel may include not only leasing the parcel for a fixed term but also selling the parcel to a third party at the end of the term (232). As with other parcel sales, the agreement may require the acquirer to pay a portion of the sales revenue to the transaction institution.

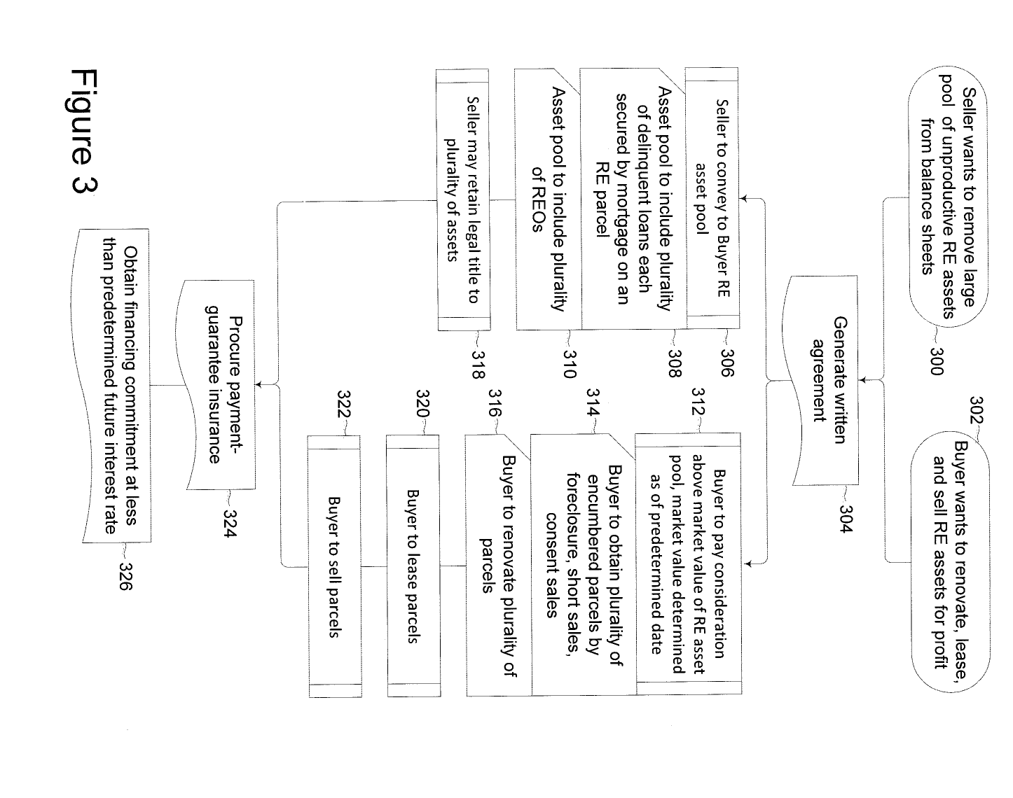

Another embodiment of a method of managing real estate is shown in FIG. 3. This method may be used by a transaction institution that wishes to remove or reduce a large pool of unproductive real estate assets from its balance sheets (300) and a developer that wishes to renovate, lease, and sell such assets for a profit (302). The method includes generating a written agreement (304) between a transaction institution and a developer and providing that:

(1) the transaction institution agrees to transfer to the developer a real estate asset pool (306) including a plurality of delinquent loans each secured by a mortgage encumbering a parcel (308) and a plurality of real estate parcels owned by the institution (310); and

(2) the developer agrees to: (a) pay the transaction institution, within a specified period of time after execution of the written agreement, a purchase price above a market value of the asset pool at a date specified by the written agreement (312); (b) obtain a plurality of the encumbered parcels by one or more of foreclosures, consensual sales, and short sales (314); and (c) renovate a plurality of the REOs and the obtained parcels (316).

In some instances the developer may agree that the transaction institution may retain legal title to assets in the pool until their sale to a third party (318). In some instances the developer may agree to lease some of the REOs and obtained parcels to third parties (320) and to pay the transaction institution part of any resulting lease revenue. In some instances the developer may agree to sell to third parties a plurality of the REOs and obtained parcels (322) and to pay the transaction institution part of any resulting sales revenue.

In some instances one of the parties agrees to procure insurance guaranteeing payment to the transaction institution of at least a portion of any funds due under the agreement (324). In some instances one of the parties may agree to provide or obtain a financing commitment at an interest rate lower than a predetermined future interest rate for loans to finance future sales of parcels to third parties (326).

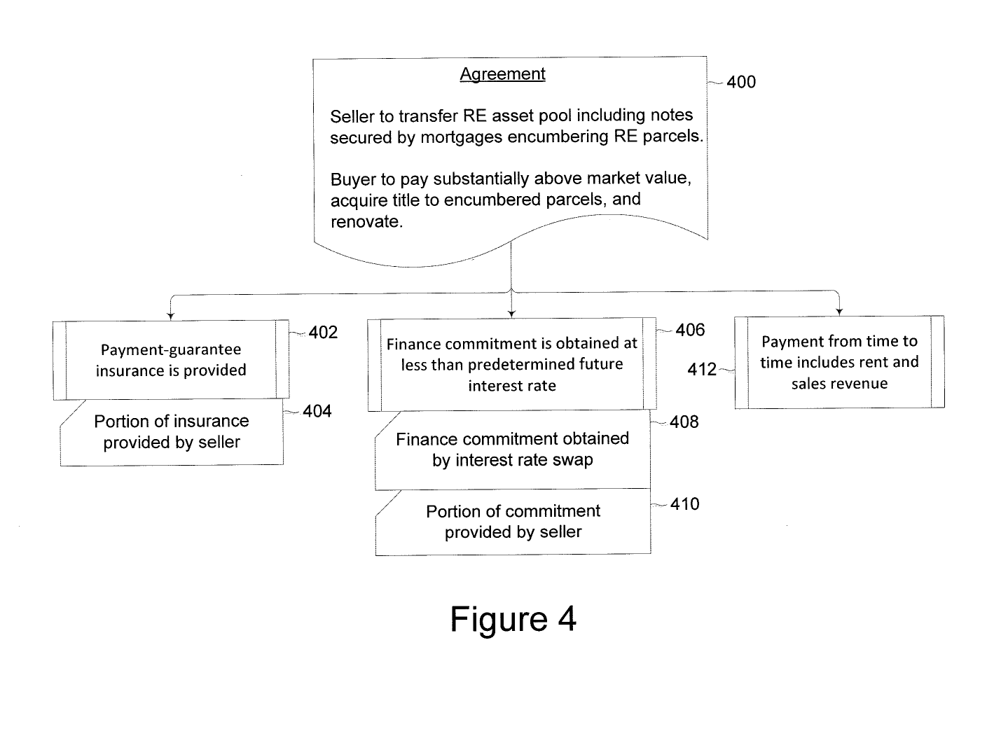

As shown in FIG. 4, another example of a method of real estate management includes causing execution of a written agreement between a transaction institution and a developer. In the agreement: the transaction institution commits to transfer to the developer a pool of real estate assets including a plurality of notes secured by mortgages encumbering parcels of real estate; and in exchange the developer commits to: (i) pay the transaction institution, within one or more years after the transaction institution transfers the pool to the developer, a price substantially above present market value of the pool; (ii) acquire title to a plurality of the encumbered parcels by foreclosure, consensual sales, and short sales and thereby add those parcels to the pool; and (iii) improve, including by physically renovating, a plurality of the assets (400).

Some instances include procuring insurance guaranteeing payment to the transaction institution of at least a portion of the price (402). At least a portion of the insurance may be provided by the transaction institution (404).

Some instances include obtaining a financing commitment at an interest rate lower than a predetermined future interest rate for loans to finance future sales of individual ones of the assets in the pool (406). At least a portion of the financing commitment may be provided by the transaction institution (408). In some instances the financing commitment may be obtained by interest rate swapping (410).

In some instances the price includes payments from time to time to the transaction institution of at least a portion of revenue received by the developer from rental and sale of pool assets (412).

In another example, a real estate developer and a real estate transaction institution, such as a bank, enter into a sale and development agreement assigning to the developer, and thus transferring ownership to the developer of, a large number of REOs and non-performing mortgages (“assets”). The sale and development agreement provides that the developer will:

(i) during an agreed period of years, assist the bank with taking title to the non-performing mortgages, through consensual conversions of mortgages into REOs via deeds-in-lieu or short sales (where possible) and otherwise through foreclosures;
(ii) renovate the REOs (including those converted or foreclosed upon) within an agreed period of years;
(iii) lease the REOs for an agreed additional period of years, with the lease payments being tendered by the tenants directly to the bank;
(iv) pay the bank agreed portions of the lease payments by allowing the bank to deduct such portions from lease payments received by the bank and to forward any remaining amounts to the developer; and
(v) at the expiration of another agreed number of years, sell the REOs over a further agreed period of time and pay the bank a portion of the sales prices, which are guaranteed by the developer to be an agreed percentage above market value at the time that the bank and developer enter into the sales and development agreement.

The sales and development agreement is structured to provide a net present value of the assets to the bank well in excess of the then-current market value of the assets at the time of entering into the sale agreement. In one embodiment, this then-current market value is as much as 50% to 70% or 80%, or more in some circumstances, over the current market value of the assets.

The sales and development agreement may also require the developer to procure insurance for the benefit of the bank guaranteeing payment to the bank of its portion of the lease payments and the agreed final payment. The sales and development agreement may also provide that the bank can pay the premiums for this insurance from the leasing revenues deposited with the bank.

The sales and development agreement may also provide that the bank will be allowed to provide credit to the developer, procure credit for the developer, or provide other services in support of the real estate transaction process contemplated by the sale agreement. In some cases, this can allow bank to generate revenues for its operations.

A present value of payments being provided to the bank by the developer may be determined in accordance with GAAP standards. In doing so, a discount rate is applied. This discount rate may be substantially lower than that expected to prevail some period of years after the sales agreement is executed by the parties. In some cases, the discount rate may be currently applicable to a number of assets that the bank otherwise would have to value differently in the future.

One way this can be accomplished is by using privately negotiated derivatives comparable to interest rate swaps (or by using conventional interest rate swaps) to lock in the cost of capital for insurance policy payments. For example, if such payments will be over 10-years, cost of capital can be locked in for each of the 10 years, with such cost used to discount future payments in calculating value.

Another approach can include applying the bank's estimated cost of capital over the applicable period for cost of capital related to similar loans. For example, if such cost is currently 50 bps, an estimate can be made of the cost of capital for each of the next nine years and then such estimates can be used in discounting payments in combination with the current rate. In some cases, a different method may be used that provides cost of capital lower than that likely provided by the bank's current approaches. While such a discount may be lower and have less up-front cost, the bank may discount the value of applicable properties in the future to the extent interest rates rise faster than estimated.

The developer then performs its obligations under the sale and development agreement. As it does so, the REOs are renovated by or for the developer as necessary or desired.

When the renovated REOs are located in a particular neighborhood or region, the renovations can improve property values of the REOs and, as a result, other properties in the neighborhood or region as well. Subsequently, as the REOs are leased, property values for the REOs and other properties can further improve. Finally, the REOs can be sold to third parties at enhanced values over a period of years after the sales and development agreement is entered into. The end result is that the sales and development process provides a relatively high net present value for the selling bank and its balance sheets, while providing a way to stabilize and improve real estate values through the process. At the conclusion of the process, the bank receives substantially higher value for the involved properties than is likely to otherwise be the case. At the same time, the real estate acquirer (developer) receives income from leasing and selling the properties in an improved real estate market. In addition, yet other properties are positively impacted by this process, and people are put to work renovating homes.

The following instances give projections for differing types of bulk sale real estate transaction processes between a real estate transaction institution (for example a bank) and a real estate acquirer (for example a developer). It is assumed in these instances that a bulk sale assigns to the developer 10,000 bank REOs and 25,000 underperforming loans secured by mortgages. The number of REOs and loans is held constant in each of these instances in order to provide a base for comparison of alteration of other aspects of the differing types of real estate transaction processes. The actual numbers of REOs, mortgages, or other assets may vary from process to process.

### Example One

In Example 1, the developer agrees to provide the selling bank with a premium of 70% above non-renovated market value on 10,000 REOs and 61% on 25,000 mortgages (assuming the mortgages become REOs up to 2-years later). This example does not necessarily include use of insurance for, or derivatives by, the selling bank or down payment to the selling bank from the developer. The selling bank receives a direct portion of the rent and direct proceeds from the future REO sales. In addition, the discount rate is locked up front so that substantial value is created even if rents fall in the future or a future sale is for less than planned. Example 1 is described in Tables 1 through 5.

TABLE 1
Exemplary Assumptions for a Representative REO

| | | |
|---|---|---|
| 1. | Anticipated Renovation Value (ARV) | $158,788 |
| 2. | Value uplift for renovation | 7% |
| 3. | Present value of mortgage | $161,000 |
| 4. | Market value as of date of sale to developer | $140,000 |
| 5. | Discount for sale as REO | 7% |
| 6. | Discounted REO value | $130,200 |
| 7. | Further discount to book value for bulk/short sale | 10% |
| 8. | Bulk/short sale value | $117,180 |

Table 1 depicts exemplary property assumptions for a representative property. Row 1 identifies the anticipated renovation value (ARV) after the property has been renovated by the developer. Row 2 identifies the percentage of value uplift for the property upon renovation by the developer. Row 3 states the value of the mortgage on such representative property. Row 4 states what the market value for such property would be if it were not an REO. Row 5 states the percentage discount for the property if it were instead to be sold as an REO to a third-party at sale transaction date with Row 6 showing such REO value (bank's primary option is to sell as a REO). Row 7 identifies a further discount in the value of the property due to the bulk sale at sale transaction date. Row 8 identifies the bulk sale value of the property at sale transaction date.

TABLE 2
Operational Assumptions for Developer During Bulk Sale

| | | |
|---|---|---|
| 1. | Price/rent ratio | 9.0x |
| 2. | Rental yield | 11.1% |
| 3. | Renovation costs as % of ARV | 6% |
| 4. | Insurance policy premium as % of ARV | 0% |
| 5. | Insurance policy premium | 0 |
| 6. | Insurance policy amortization (years) | 10 |
| 7. | Initial monthly carrying cost as % of monthly expenses | 52% |
| 8. | Annual rent increases | 3% |
| 9. | Inflation (cash earns interest at this rate) | 3% |
| 10. | Operational expenses as % of annual rent | 43% |
| 11. | Tax rate on income | 23% |
| 12. | Tax on final sale of property in year 10 | 23% |
| 13. | Excess cash requirement | $9,000 |
| 14. | Management fees (years 2-5, annual amount) | 0 |

Table 2 identifies operations assumptions for the developer during the bulk sale real estate transaction process. Row 1 identifies the property price to rent ratio when the property is leased, with the property value. Row 2 identifies the rental amount as a percentage of value. Row 3 identifies renovation costs as a percentage of as renovated value of the property. Row 4 addresses the premium to be paid to insure the final payment to the bank on sale of the property; this row identifies that premium as a percent of as renovated value for the property. (There is no such insurance in this Example 1) Row 5 identifies the amount of the premium in dollars. Row 6 identifies the number of years the premium will be amortized for accounting purposes (whether it is paid in cash upfront or over time). Row 7 identifies the developer's monthly carrying cost for the property, during the period it is being renovated (or held without a tenant), as a percent of monthly expenses incurred by the developer for the property. Row 8 states the percentage of annual rent increases to the lessee of the property. Row 9 identifies the inflation rate. Row 10 identifies the developer's operational expenses as a percentage of rent. Row 11 identifies the developer's income tax rate. Row 12 identifies the developer's tax rate on income at final sale of the property. Row 13 identifies the minimum amount of cash that must be maintained during the first 5-years of the captive insurance plan (if implemented at request of selling bank). Row 14 identifies annual management fees that in some cases may be charged by the developer for managing the property in years 2 through 5 after entering into the sale and development agreement with the developer. Other fees may be charged by mutual consent of the parties.

TABLE 3
Transaction Assumptions Developer - Selling Bank

| | | |
|---|---|---|
| 1. | Percent of bank book value (BV) paid up front | 0% |
| 2. | Percent of bank BV paid at end | 97% |
| 3. | Discount rate for time value of selling bank payments | 2.7% |
| 4. | Interest rate for seller bank loan | 2.7% |
| 5. | Seller bank rent participation | 40% |
| 6. | Seller bank rent participation annual increase | 0% |
| 7. | NPV to selling bank of all payments over time | $221,340 |
| 8. | Implied premium to bank realizable value | 70% |
| 9. | Implied premium to mortgage | 37% |

Table 3 identifies transaction process assumptions for the selling bank. Row 1 gives the amount paid by the developer to the bank up front, at closing of the sales and development agreement, as a percentage of the book value of the property at the time of this payment. Such payment will be negotiated with the selling bank, which may choose to waive it in exchange for other consideration (such payment is not included in this example). Row 2 is the amount paid by the developer to the bank at the end of transaction process (in this example, ten years after entering into the sale and development agreement for the property) as a percent of book value for the property at the time of this payment. Row 3 is the discount rate applied to payments made to the selling bank by the developer. Row 4 is the imputed interest rate for the selling bank for tax purposes. Row 5 is the percent of rent received by the bank. Row 6 is the annual increase in the amount identified in Row 5. Row 7 is the net present value (NPV) to the bank of all payments to the bank by the developer for the property over time. Row 8 is the percentage by which row 7 exceeds the REO value of Table 1, Row 6. Row 9 is the percentage by which row 7 exceeds the mortgage value of row Table 1, Row 3.

TABLE 4
Transaction Assumptions Developer - External Capital

| | | |
|---|---|---|
| 1. | Capital raise (senior loan) as % of ARV | 20% |
| 2. | Implied senior loan | $31,758 |
| 3. | Financing rate for external capital | 5% |
| 4. | External capital payment-in-kind (PIK) | 0% |
| 5. | Percent of senior loan outstanding at end of transaction | 50% |
| 6. | Implied senior loan outstanding at end | $15,879 |

Table 4 identifies transaction process assumptions for external capital to be borrowed by the developer for purposes of implementing the process for the property. Row 1 identifies the capital raise (“senior loan”) to be borrowed by the developer as a percent of the as-renovated value of the property. Row 2 states amount of this senior loan for the property. Row 3 identifies the financing interest rate for the senior loan. Row 4 states the percent of external capital that is payment in kind (PIK) capital. Row 5 is the percent of the senior loan outstanding at the end date for the sale of the property. Row 6 is the amount of senior loan remaining at the end date for the sale of the property.

TABLE 5
Transaction Assumptions Developer Profits

| | | |
|---|---|---|
| 1. | Final sale cap rate | 6% |
| 2. | Discount rate to developer for value calculations | 2% |
| 3. | PV to developer of final cash distribution | $34,549 |
| 4. | Actual cash payout to developer at year 10 | $42,115 |

Table 5 gives transaction assumptions for the developer profit earned in the transaction process for the property. Row 1 is the cap rate for the developer at the final sale of the property. Row 2 is discount rate by the developer for value calculations during the transaction process. Row 3 is the present value of the property to the developer of the final cash distribution to the developer upon sale of the REO. Row 4 is the total payout to the developer after the final sale of the property to a third party.

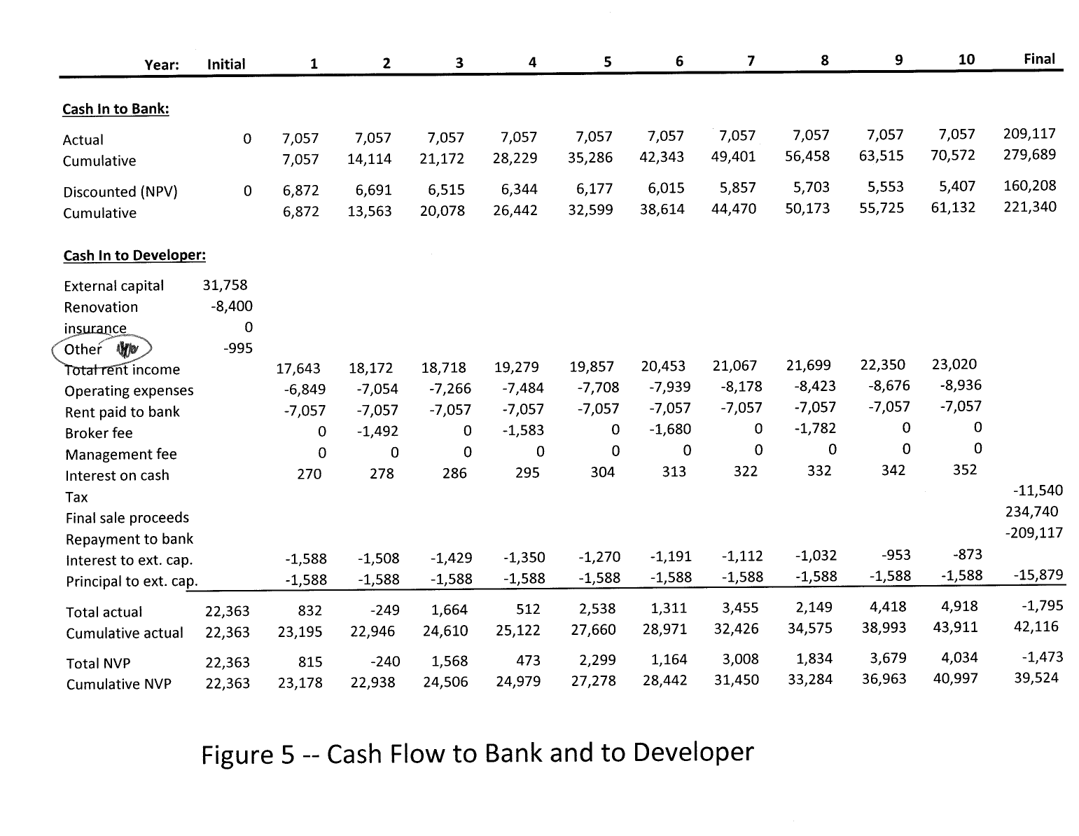

FIG. 5 shows the initial, annual, and final cash payments to be made to the bank by the developer for the property referenced in Tables 1-5, the total annual cash flow and total cumulative cash flow to the bank based on these payments, the net present value to the bank of these cash payments and flows. and the cash flows of the developer with respect to the property during the real estate transaction process. The term “Other YO” means income and expenses after the property is acquired but prior to its lease to a third-party (typically, 3 months but this time period can vary). The last two rows show the total cash flow for the developer for the property and the net present value to the developer of that cash flow.

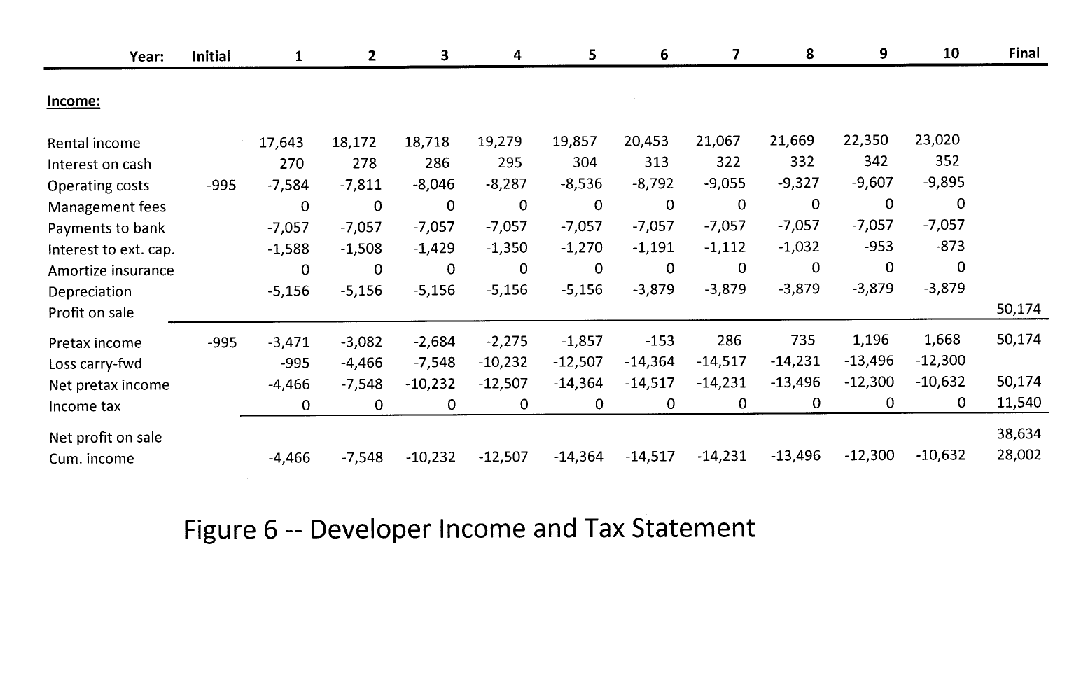

FIG. 6 sets forth the income and tax statement for the developer with regard to the sample property during the transaction process. The insurance policy amortization is the amortization expense for the insurance policy premium identified above. Net annual income to the developer for the property is identified and will be utilized for such purposes as tax returns. The developer's annual income statement with accumulated loss carry-overs excludes final sale of the property.

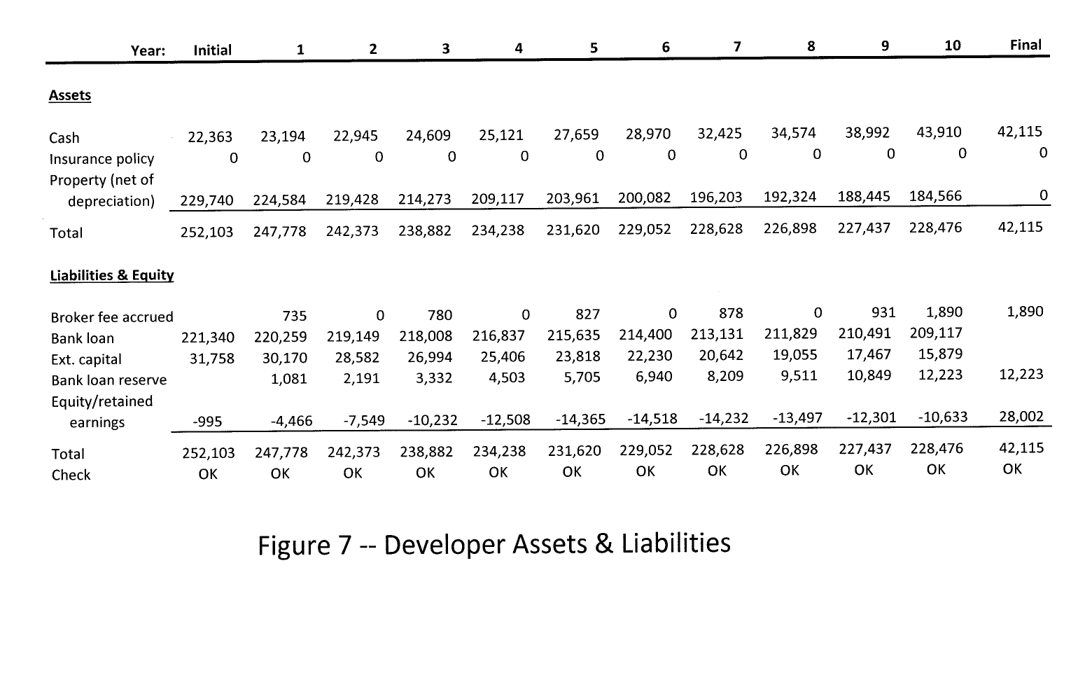

FIG. 7 presents the developer's balance sheet with respect to the sample property project.

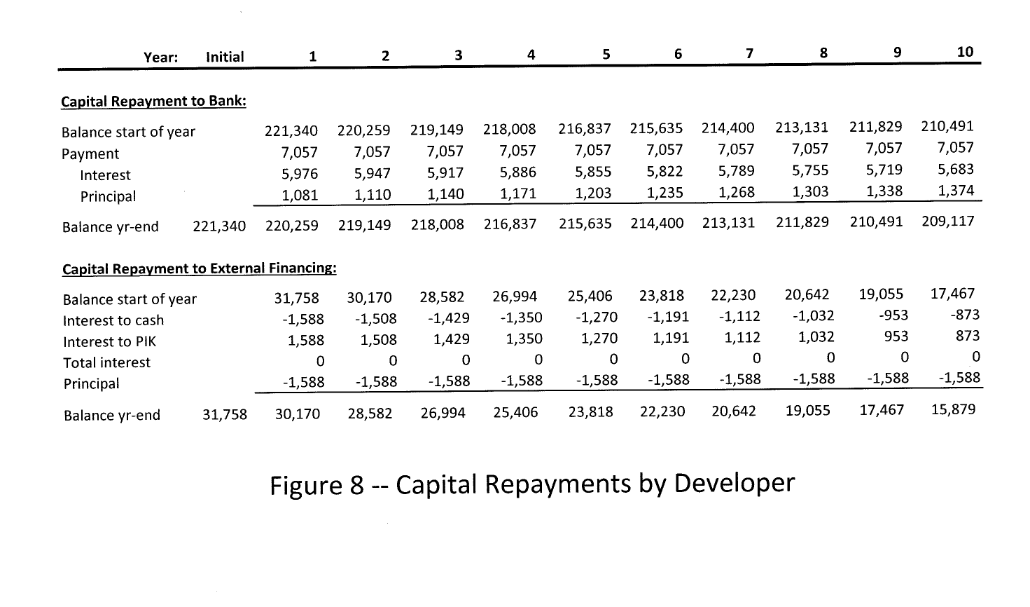

FIG. 8 in “capital repayment to bank” shows the annual status of the stream of capital payments to the bank (payments by the developer for the parcel) if treated as repayment of a loan from the bank to the developer. This is primarily shown for tax purposes. The bank (seller) may choose to account for the sale in such manner, but this will not change the manner of the cash payments to the bank. The final payment from the developer ($209,117 in this example) pays the remaining balance due for the property, so there are no residual amounts remaining for tax purposes or otherwise. The line “balance at year end” for each year is computed by subtracting the principal payment in that year from the balance at start of year. Similarly, “capital repayment to external financing” shows repayments to an external finance entity. Also shown is the annual status of the external, senior capital financing procured by the developer. The developer pays any remaining balance when the property is sold ($15,879 in this example), as well as the final payment to the selling bank, from the proceeds of the eventual sale of the property.

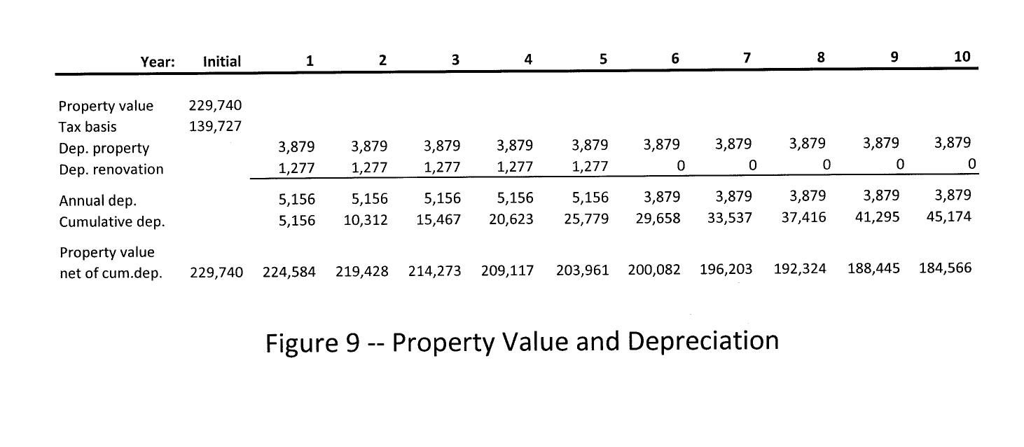

FIG. 9 shows the developer's depreciation schedule for the property and the net book value of the property to the developer.

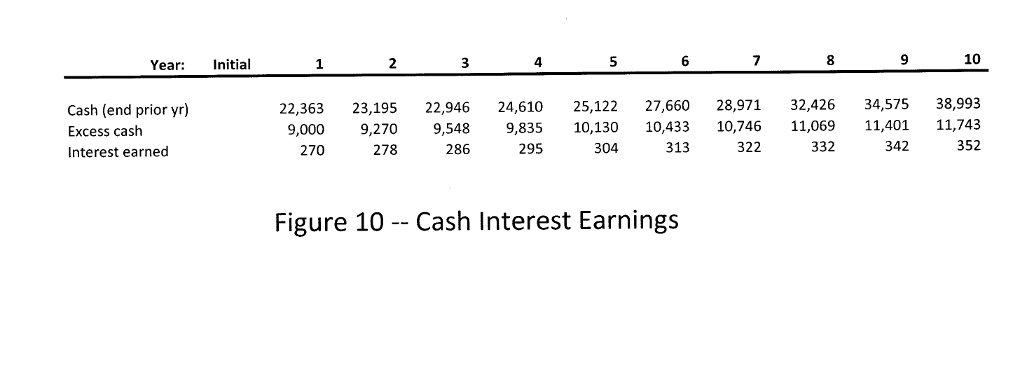

FIG. 10 shows the cash interest earned by the developer from the project for this property.

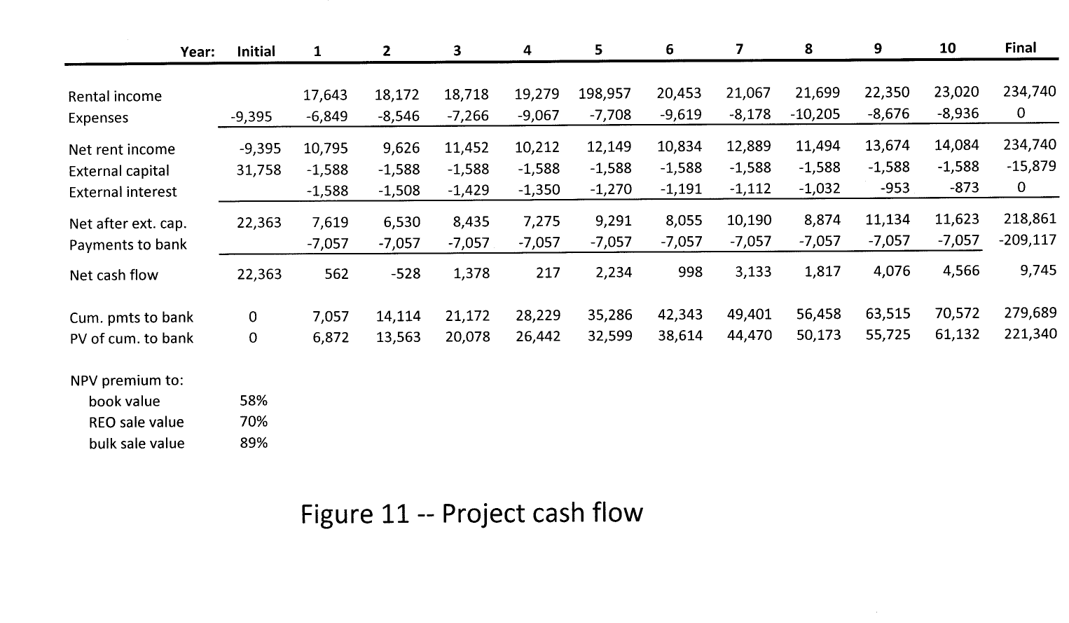

FIG. 11 and Table 6 show data reported above along with the developer's residual cash flow and the selling bank's cash flow after project expenses. The selling bank's cumulative cash flow includes:

“payments to bank”—the bank's present value, at signing of the agreement, of the cash flow for this nonperforming mortgage and related property, including the total of $209,117;

“net cash flow”—the percentage increase in the selling bank's net present value as compared to book value of the nonperforming mortgage at signing of the agreement;

“cumulative payments to bank”—the percentage increase in the selling bank's net present value as compared to REO sale value for the applicable property if foreclosed upon and sold at signing of the agreement; and

“PV of cumulative payments to bank”—the percentage increase in the selling bank's net present value as compared to bulk sale/short sale value at signing of the agreement.

TABLE 6
Property characteristics and operating assumptions

| Property characteristics | |
|---|---|
| Mortgage value | $161,000 |
| Full market value | 140,000 |
| REO sale value | 130,200 |
| Bulk sale value | 117,180 |
| Value after renovation | 158,788 |
| Key operating assumptions | |
| Property price/rent ratio | 9.0x |
| Operating cost as % of rental income | 43% |
| Selling bank cost of capital (for PV calc.) | 2.7% |
| External debt provider cost of capital | 5% |
| Final sales cap rate | 6% |

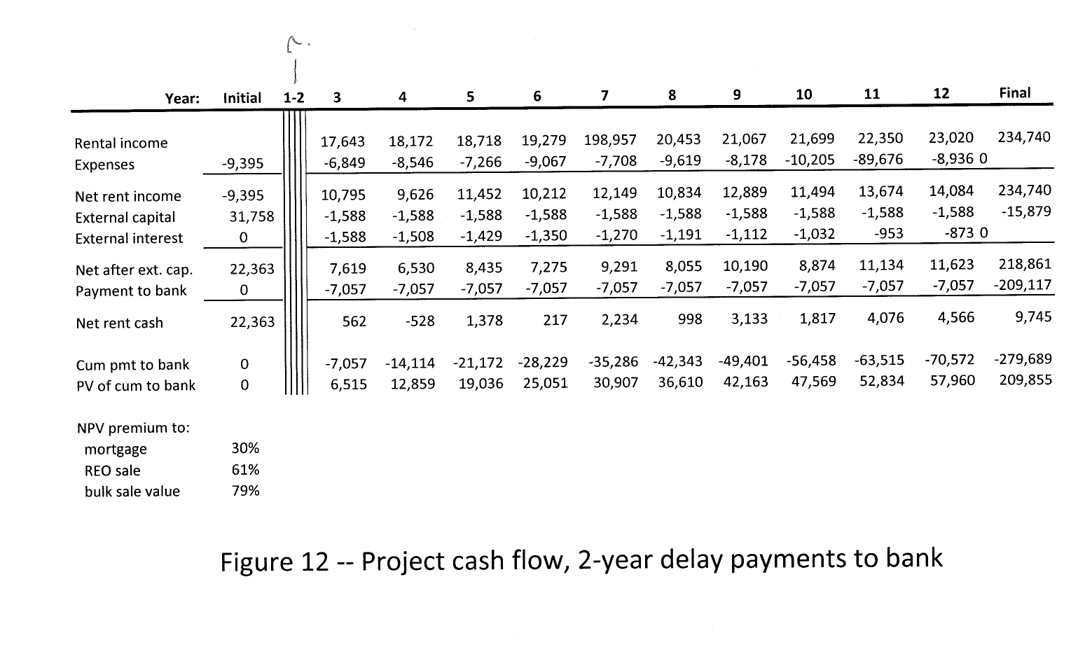

Referring again to Table 6, and with reference to FIG. 12, data reported previously are included but are applied to provide projections for an average nonperforming mortgage acquired from the bank by the developer and all 25,000 nonperforming mortgages. Also included are nonperforming mortgage property cash flows after expenses, after external capital, and after seller bank's loan; and cumulative selling bank cash flow.

Tables 7 through 11 include data described above, except that rather than showing a single-property, all 10,000 REOs are shown. In other words, these tables report the same average data with the same numerical values but for all 10,000 REOs.

TABLE 7
Property Assumptions (10,000 parcels)

| | |
|---|---|
| “As Renovated” value of property (“ARV”) | $1,587,880,000 |
| Value uplift for renovation | 7% |
| Mortgage value | $1,610,000,000 |
| Full market value | $1,400,000,000 |
| REO discount | 7% |
| REO value | $1,302,000,000 |
| Further discount to book value for bulk or short sales | 10% |
| Bulk or short sale value | $1,171,800,000 |

TABLE 8
Operational Assumptions

| Price/rent ratio (at NRV) | 9.0x |
|---|---|
| Rental yield (% of NRV) | 11.1% |
| Renovation cost (% of NRV) | 6% |
| Insurance policy premium (% of NRV) | 0 |
| insurance policy premium | $4,000.00 |
| Insurance policy amortization (years) | 10 |
| Initial monthly carrying cost (% of monthly expenses) | 52% |
| Annual rent increases | 3% |
| Inflation (rate at which cash would earn interest) | 3% |
| Operational expenses (% of annual rent) | 43% |
| Tax rate on income | 40% |
| Tax on final sale of properties in year 10 | 23% |
| Excess cash required | $9,000.00 |
| Management fees (years 2-5) | 0 |

TABLE 9
Transaction assumptions - acquirer to selling bank

| | |
|---|---|
| Percent of bank BV paid up-front | 20% |
| Percent of bank BV paid at end | 97% |
| Discount rate for time value of selling bank's | 3% |
| payments | |
| Interest rate for bank loan (same as TVM discount | 3% |
| rate) | |
| Seller bank rent participation | 30% |
| Seller bank rent participation in annual increases | 0 |
| NVP to selling bank of all payments over time | $2,213,400,000* |
| (*$221,340 per parcel) | |
| Implied premium to bank realizable value | 70% |
| Implied premium to bank if short or bulk sale | 89% |

TABLE 10
Transaction assumptions - acquirer to external capital

| | |
|---|---|
| Capital raise (senior loan) as % of ARV | 35% |
| Senior loan | $555,758,000 |
| Financing rate for external capital | 5% |
| External capital PIK | 0 |
| Percent of senior loan outstanding at end | 39.2% |
| Senior loan outstanding at end of transaction | $217,864,572 |

TABLE 11
Transaction assumptions - acquirer profit

| | |
|---|---|
| Final sale cap rate | 6% |
| Discount rate to acquirer for value calculations | 2% |
| PV to acquirer of final cash distribution | $34,549.00 |
| Actual cash payout to acquirer at year 10 | $42,115 |

### Example Two

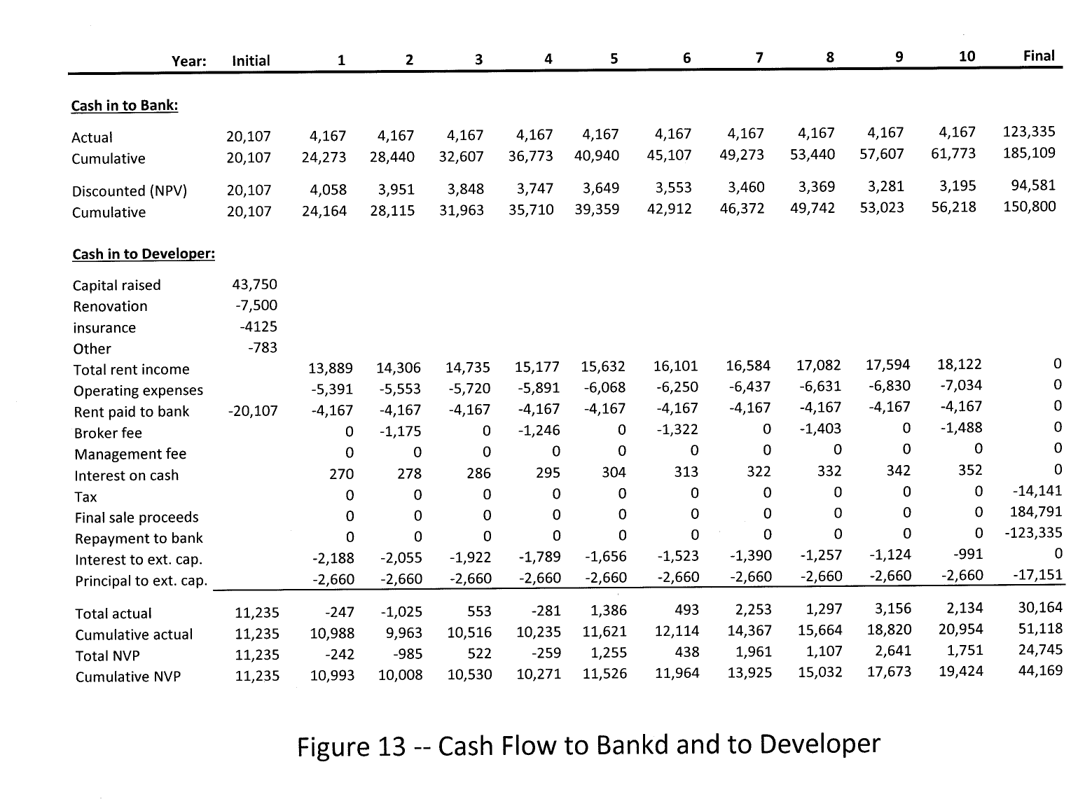

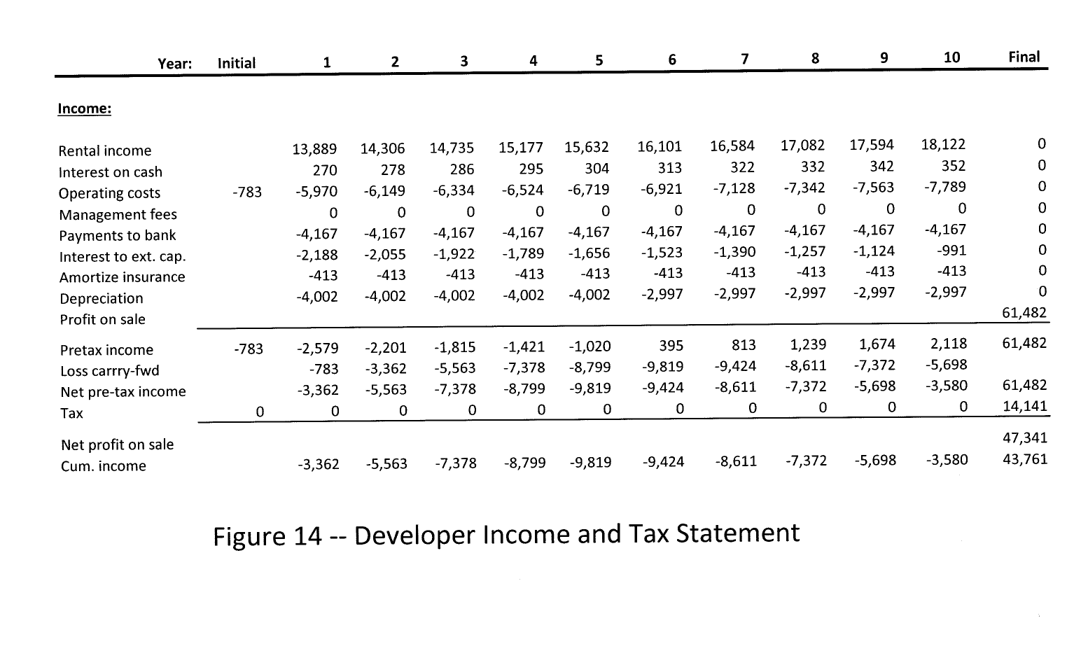

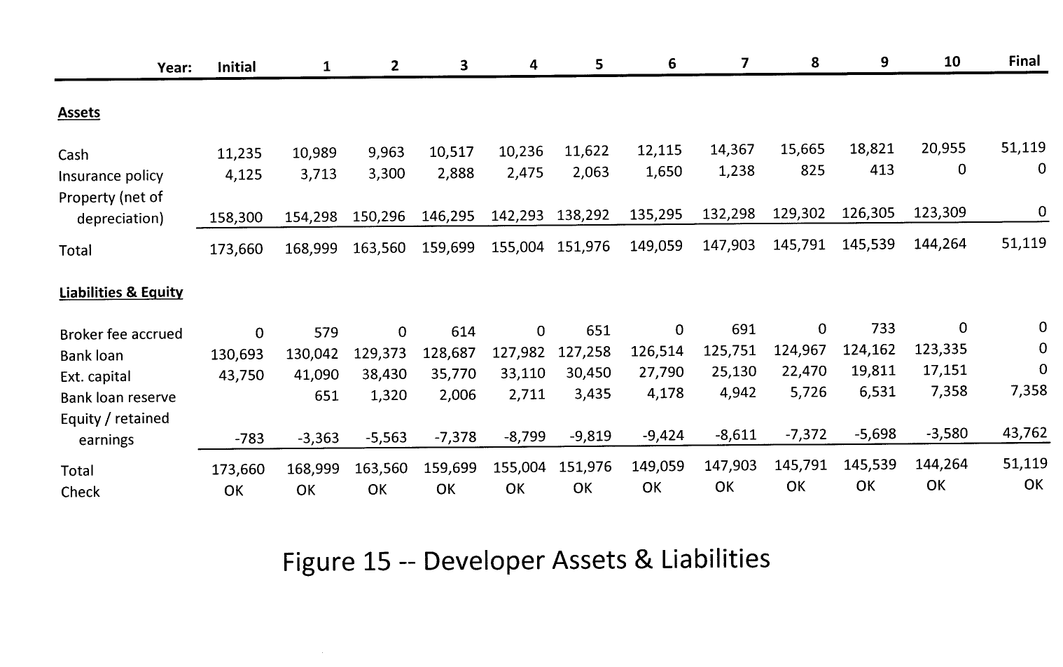

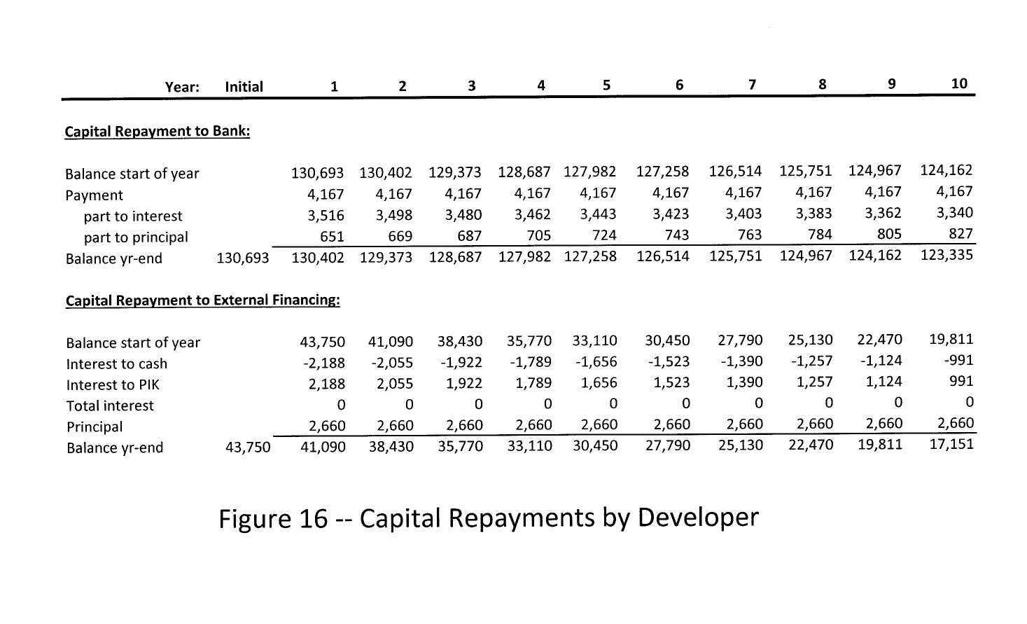

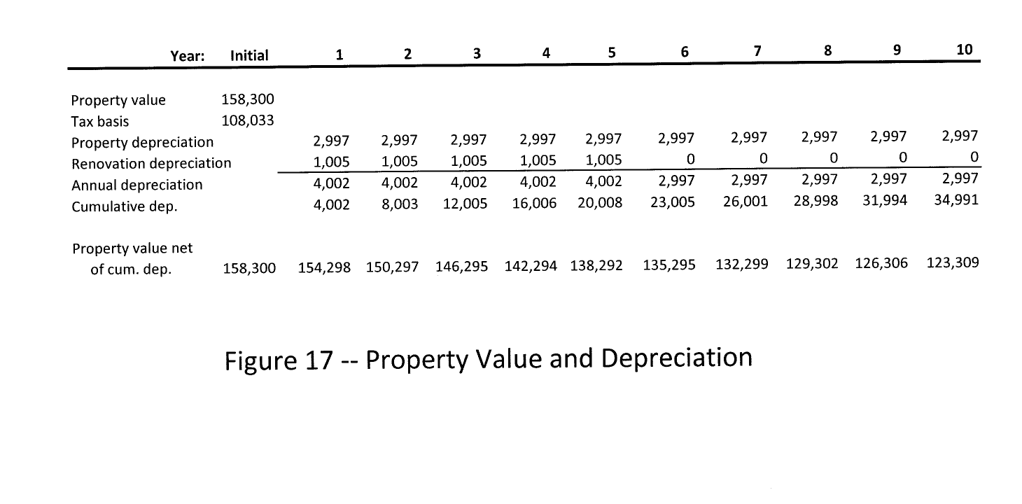

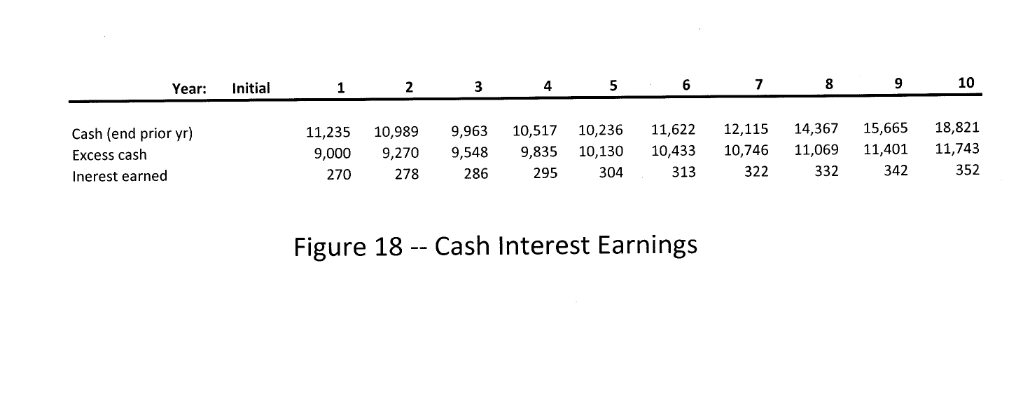

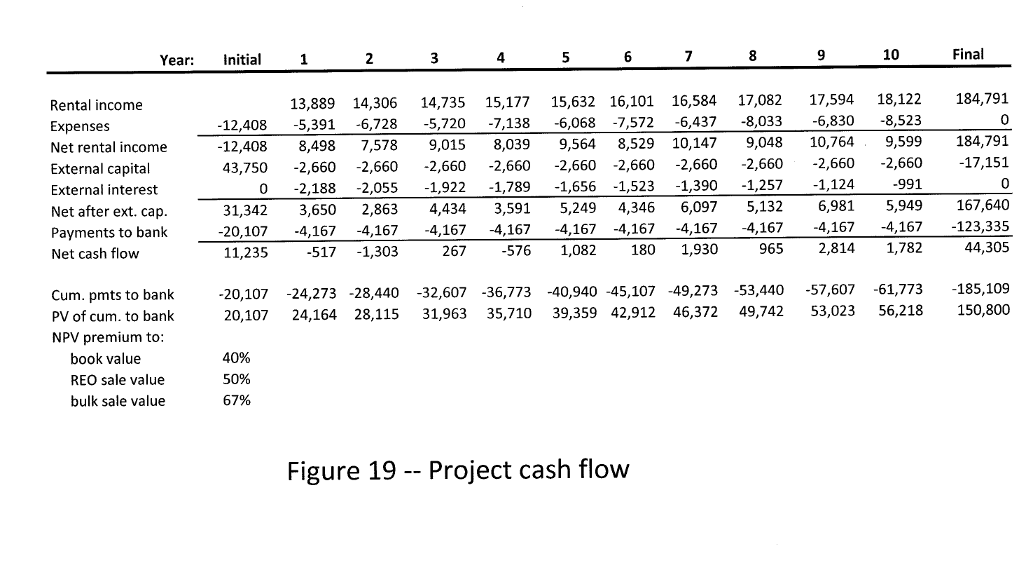

Referring now to FIGS. 13-19 and Table 12, FIGS. 13-19 are similar to FIGS. 5-11, respectively, but illustrate data for Example Two rather than Example One. In Example 2 it is assumed that the developer purchases a portfolio of properties from the selling institution for 50% above non-renovated market value of the REO's and 40% above book (mortgage) value of the non-performing mortgages at the time of entering into to the agreement. The number of properties could be any useful number. In this Example Two, 10,000 REOs and 25,000 non-performing mortgages are included. In addition, this Example assumes that the developer does not take mortgages from the selling institution over time; rather, every property is assumed to be an REO.

If the selling bank has fully written down the value of a mortgage on its balance sheet to market value, then there will be no difference between the spread to market and the spread to mortgage at the time of entering into the agreement. For example, if the bank has written down the value of a mortgage to $100,533, then this proposal would offer 50% above mortgage rather than 40% as shown in the figures.

If the selling bank has not taken much of a write-down for a given mortgage, it may be carrying some mortgages at 30-40% above market value on its books, rather than the 7% uplift of this example. Other instances in this specification show scenarios closer to such a situation.

Thus, the real estate transaction process described in this specification can allow for a significant positive spread of present value (by reason of the process and sales and development contract) to market value. This spread can be more than sufficient to cover the full face value of mortgages at the time of execution of the agreement and in some cases to provide substantial additional profit.

In Example Two, the selling bank is provided with both captive insurance for the annual payments as well as insurance for the final payments shown in the accompanying table and figures. The amounts of such payments and associated insurance can vary depending on such matters as market conditions and negotiations between the parties. Such insurance is a unique offering of the developer and may be attractive to the bank but is not required for purposes of the agreement.

In this Example Two the selling bank receives a down-payment of $20,107 for each property. This is not a requirement for all transactions, but it can be offered if needed. Interest rate swaps provide a discount rate of 2.7%. This rate would have been 2.5% using an “estimated cost of capital” approach.

TABLE 12
Property characteristics and operating assumptions

| Property characteristics | |
|---|---|
| Book value at bank | 108,100 |
| REO sale value | 100,533 |
| Value after renovation | 125,000 |
| Key operating assumptions | |
| Property price/rent ratio | 9.0x |
| Operating cost as % of rental income | 43% |
| Selling bank cost of capital (for PV calc.) | 2.7% |
| External debt provider cost of capital | 5% |
| Final sales cap rate | 6% |

### Example Three

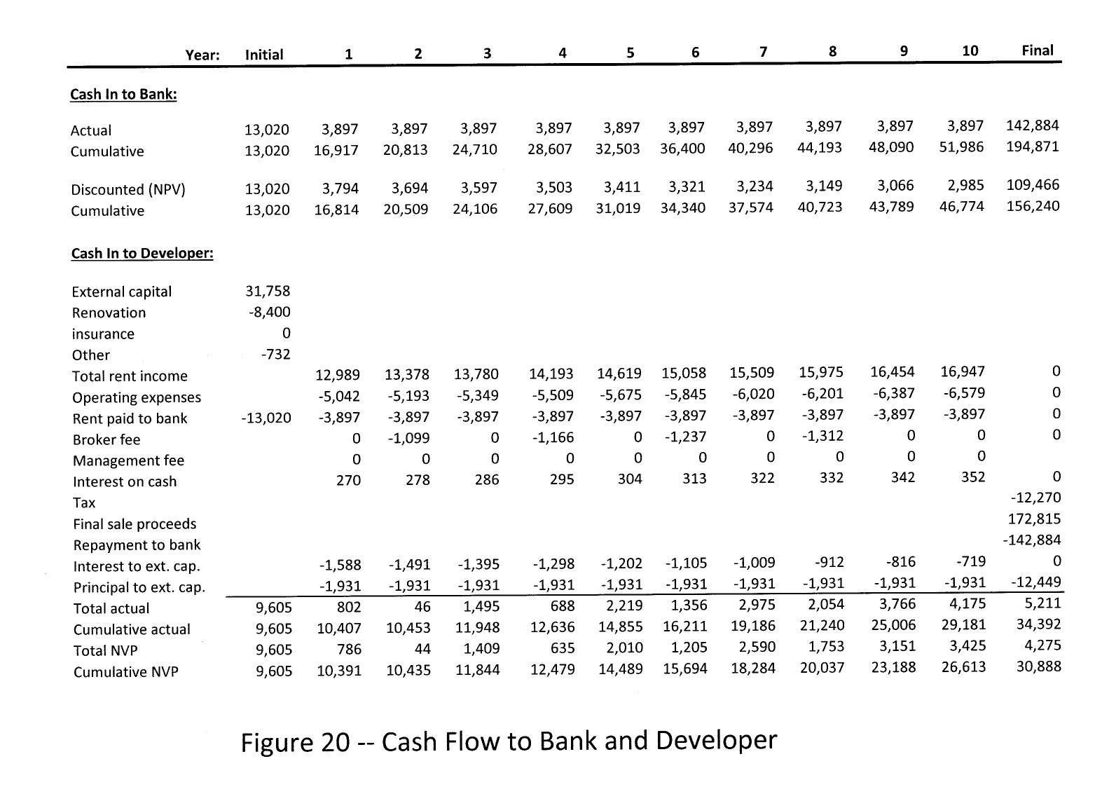

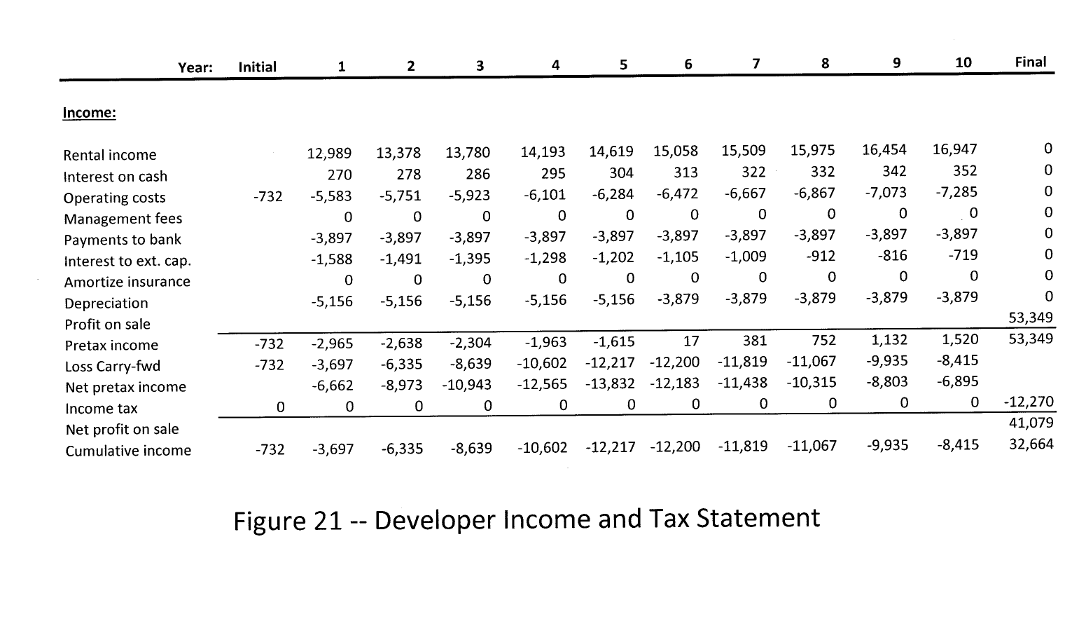

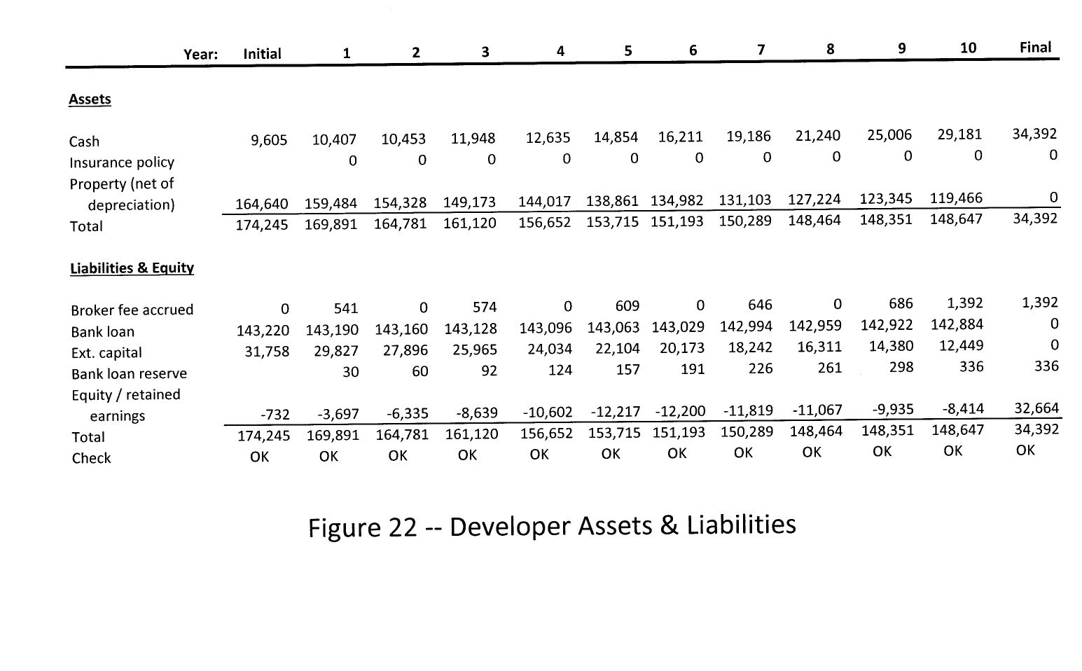

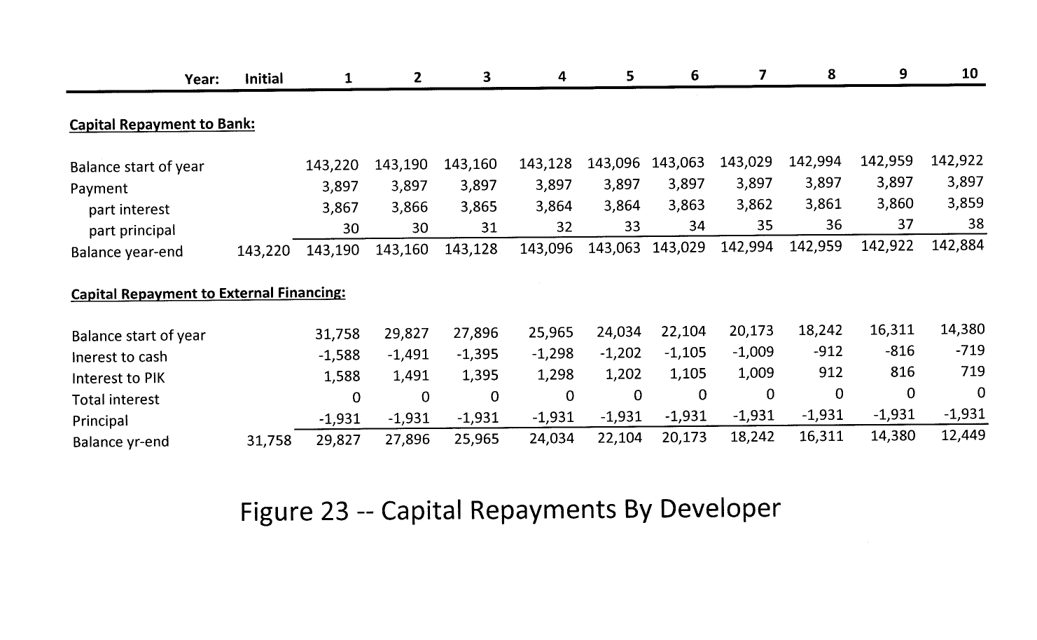

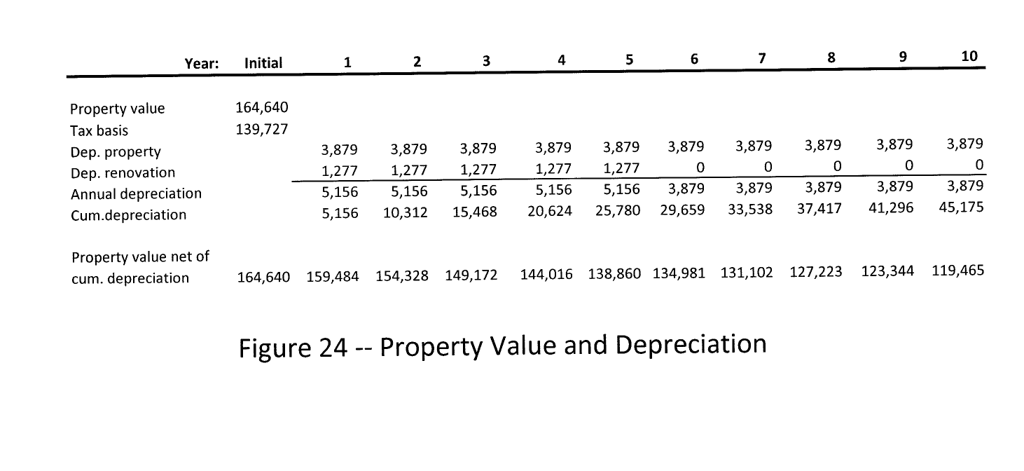

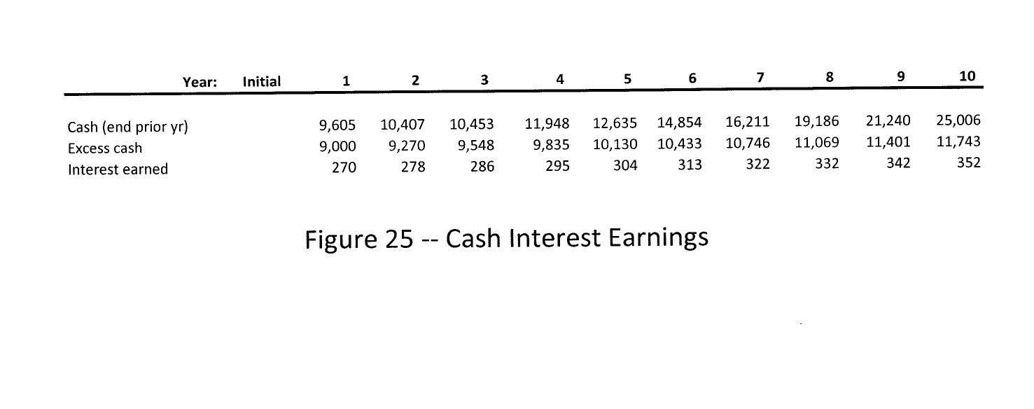

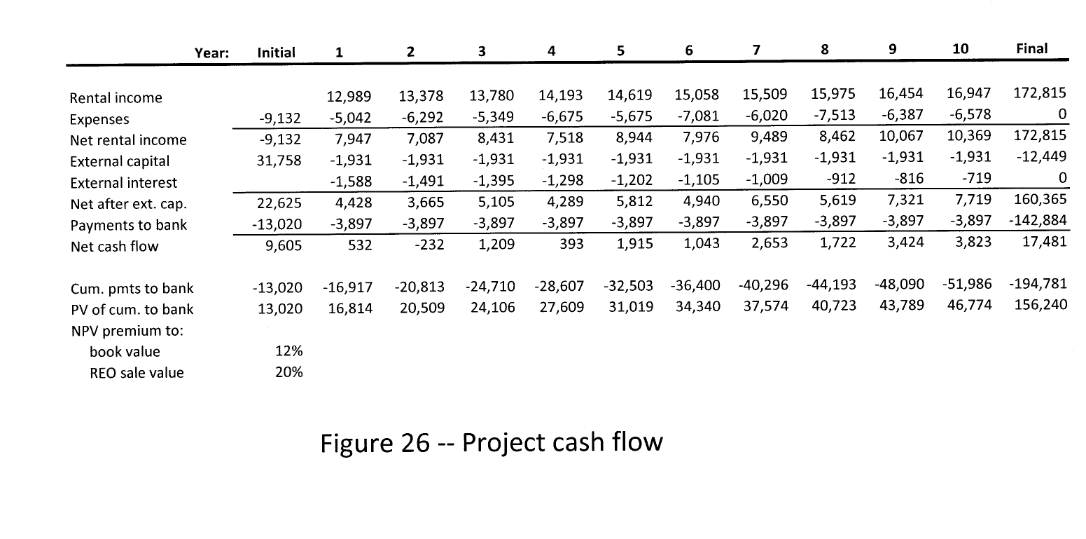

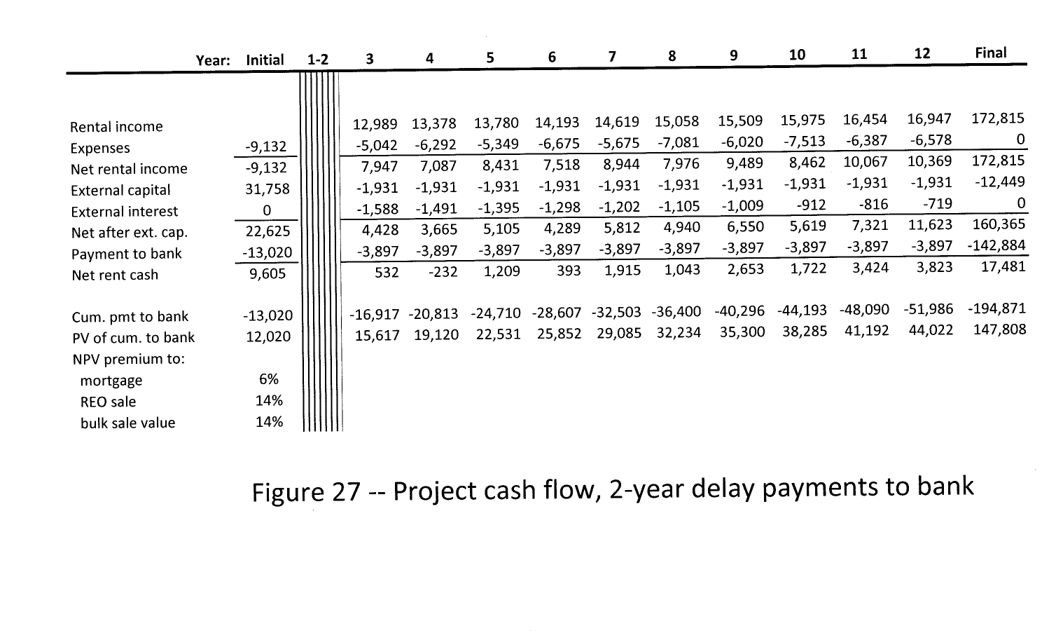

Example Three is illustrated in Tables 13 through 23 and FIGS. 20 through 27. FIGS. 20-27 are similar to FIGS. 5-12, respectively, but illustrate data for Example Three rather than Example One. FIG. 26 along with Table 18 give financial projections for a single average REO. Tables 19-23 give financial projections for a bulk sale of 10,000 REOs. FIG. 27 also along with Table 18 give financial projections for a bulk sale of 25,000 mortgages. The meanings of the various entries will be apparent by reference to the foregoing discussion and therefore are not repeated here.

Example Three shows a portfolio of properties acquired in a transaction process at a 5% cap rate (still offering 20% above market) whereas Example Four (to be discussed presently) shows a portfolio of properties acquired at a 5.5% cap rate (still offering 40% above market). These are very low cap rates for a portfolio. Many investors will not dip below 6% on the cap rate. These instances, however, still provide substantial value to the acquirer and its investors, if any, and developer can acquire properties at even lower cap rates if necessary.

In Example Three, the acquirer pays the selling bank a 10% down payment, but the selling bank does not receive insurance on the annual or final payments. Such insurance could be provided in certain cases (even though it is not shown in this example). The selling bank would still have the right to receive insurance via a policy against losses for the overall portfolio, which would be factored into the pricing of value.

In some embodiments this policy can guarantee receipt of an amount equal to the value of the mortgage (or in the case of a REO, the original mortgage) even if such mortgage is substantially greater than the market value of the underlying property. In many cases the policy may provide substantial value above the mortgage, thus allowing for recovery of foreclosure costs, unpaid interest, and cost of capital. The seller (bank) may be able to release most mortgagors from their obligations without the need for a short sale, even if such borrowers are substantially under water. The policy may provide the seller with a definitive value for the assets as of the date of transfer; at minimum this would be equal to the value of the current mortgage. For REOs, the minimum value may be the value of the original mortgage, and for all assets the value may be as much as 70% above market-value for the applicable property.

TABLE 13
Property Assumptions (10,000 parcels)

| | |
|---|---|
| “As Renovated” value of property (“ARV”) | $158,788 |
| Value uplift for renovation | 7% |
| Mortgage value | $130,200 |
| Full market value | $140,000 |
| REO discount | 7% |
| REO value | $130,200 |

TABLE 14
Operational Assumptions

| | |
|---|---|
| Annual rent | $12,989 |
| Gross margin | $7,947 |
| Cap rate (ARV) | 5% |
| Price/rent ratio (at NRV) | 12.2xx |
| Rental yield (% of NRV) | 8.2% |
| Renovation cost (% of NRV) | 6% |
| Insurance policy premium (% of NRV) | 0 |
| insurance policy premium | $10 |
| Insurance policy amortization (years) | 10 |
| Initial monthly carrying cost (% of monthly expenses) | 52% |
| Annual rent increases | 3% |
| Inflation (rate at which cash would earn interest) | 3% |
| Operational expenses (% of annual rent) | 43% |
| Tax rate on income | 40% |
| Tax on final sale of properties in year 10 | 23% |
| Excess cash required | $9,000 |
| Management fees (years 2-5) | 0 |

TABLE 15
Transaction assumptions - acquirer to selling bank

| | |
|---|---|
| Percent of bank BV paid up-front | 10% |
| Percent of bank BV paid at end | 97% |
| Discount rate for time value of selling bank's payments | 2.7% |
| Interest rate for bank loan (same as TVM discount rate) | 2.7% |
| Seller bank rent participation | 30% |
| Seller bank rent participation in annual increases | 0 |
| NVP to selling bank of all payments over time | $156,240 |
| Implied premium to bank realizable value | 20% |
| Implied premium to bank if short or bulk sale | 20% |

TABLE 16
Transaction assumptions - acquirer to external capital

| | |
|---|---|
| Capital raise (senior loan) as % of ARV | 20% |
| Senior loan | $31,758 |
| Financing rate for external capital | 5% |
| External capital PIK | 0 |
| Percent of senior loan outstanding at end | 39.2% |
| Senior loan outstanding at end of transaction | $12,449 |

TABLE 17
Transaction assumptions - acquirer profit

| | |
|---|---|
| Final sale cap rate | 6% |
| Discount rate to aquirer for value calculations | 2% |
| PV to acquirer of final cash distribution | $28,214 |
| Actual cash payout to acquirer at year 10 | $34,392 |

TABLE 18
Property characteristics and operating assumptions

| | |
|---|---|
| Property characteristics | |
| Mortgage value | $130,200 |
| Full market value | 140,000 |
| REO sale value | 130,200 |
| Value after renovation | 158,788 |
| Key operating assumptions | |
| Property price/rent ratio | 12.2x |
| Operating cost as % of rental income | 43% |
| Selling bank cost of capital (for PV calc.) | 2.7% |
| External debt provider cost of capital | 5% |
| Final sales cap rate | 6% |
| For 25,000 mortgages at $130,200: | |
| Mortgage value = REO value = $3,255,000,000 | |
| Offer to bank = $3,695,207,538 | |
| For 30,000 mortgages: | |
| Mortgage value = REO value = $3,906,000,000 | |
| Offer to bank = $4,434,249,045 | |

TABLE 19
Property Assumptions (10,000 parcels)

| | |
|---|---|
| “As Renovated” value of property (“ARV”) | $1,587,880,000 |
| Value uplift for renovation | 7% |
| Mortgage value | $1,302,000,000 |
| Full market value | $1,400,000,000 |
| REO discount | 7% |
| REO value | $1,302,000,000 |
| Further discount to book value for bulk/short sale | 10% |

TABLE 20
Operational Assumptions

| Price/rent ratio (at NRV) | 9.0x |
|---|---|
| Rental yield (% of NRV) | 11.1% |
| Renovation cost (% of NRV) | 6% |
| Insurance policy premium (% of NRV) | 0 |
| insurance policy premium | $4,000 |
| Insurance policy amortization (years) | 10 |
| Initial monthly carrying cost (% of monthly expenses) | 52% |
| Annual rent increases | 3% |
| Inflation (rate at which cash would earn interest) | 3% |
| Operational expenses (% of annual rent) | 43% |
| Tax rate on income | 40% |
| Tax on final sale of properties in year 10 | 23% |
| Excess cash required | $9,000 |
| Management fees (years 2-5) | 0 |

TABLE 21
Transaction assumptions - acquirer to selling bank

| | |
|---|---|
| Percent of bank BV paid up-front | 20% |
| Percent of bank BV paid at end | 97% |
| Discount rate for time value of selling bank's | 3% |
| payments | |
| Interest rate for seller bank loan | 3% |
| (same as TVM disc. rate) | |
| Seller bank rent participation | 30% |
| Seller bank rent participation in annual increases | 0 |
| NVP to selling bank of all payments over time | $1,562,400,000* |
| *$156,240 per parcel | |
| Implied premium to bank realizable value | 20% |
| Implied premium to bank if short or bulk sale | 20% |

TABLE 22
Transaction assumptions - acquirer to external capital

| | |
|---|---|
| Capital raise (senior loan) as % of ARV | 35% |
| Senior loan | $555,758,000 |
| Financing rate for external capital | 5% |
| External capital PIK | 0 |
| Percent of senior loan outstanding at end of transaction | 39.2% |
| Senior loan outstanding at end of transaction | $217,864,572 |

TABLE 23
Transaction assumptions - acquirer profit

| | |
|---|---|
| Final sale cap rate | 6% |
| Discount rate to acquirer for value calculations | 2% |
| PV to acquirer of final cash distribution | $28,214 |
| Actual cash payout to acquirer at year 10 | $34,392 |

### Example Four

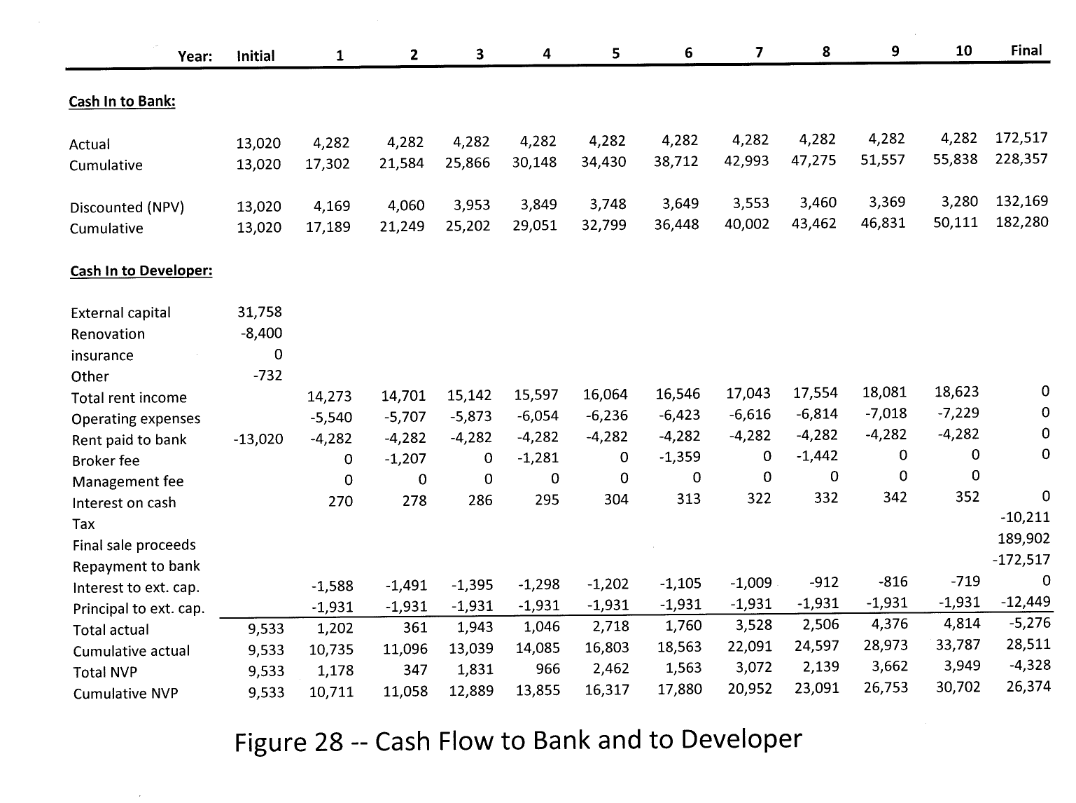

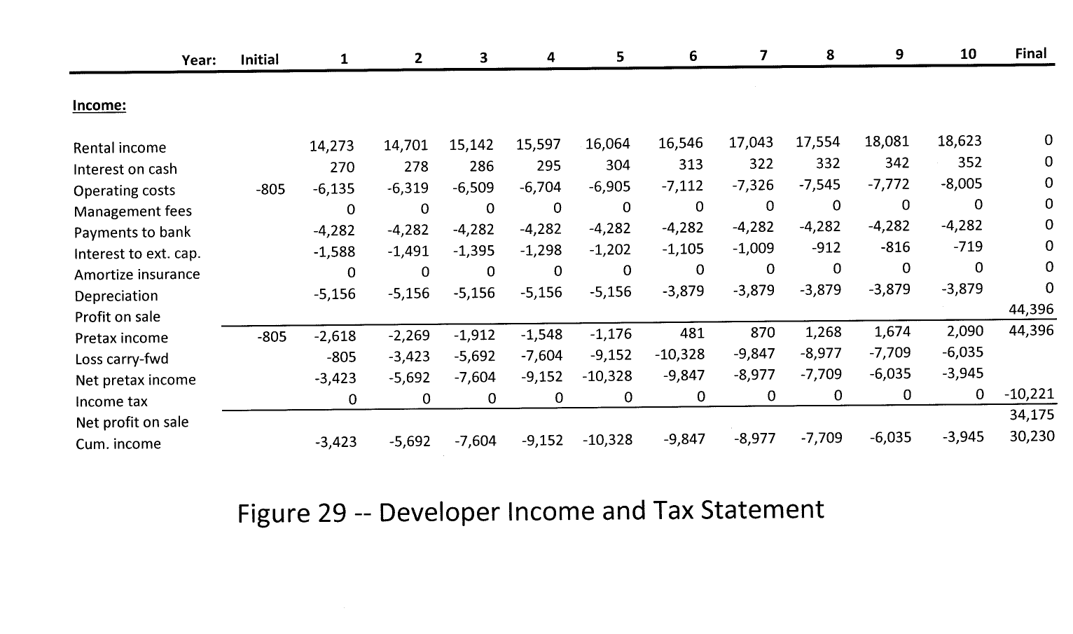

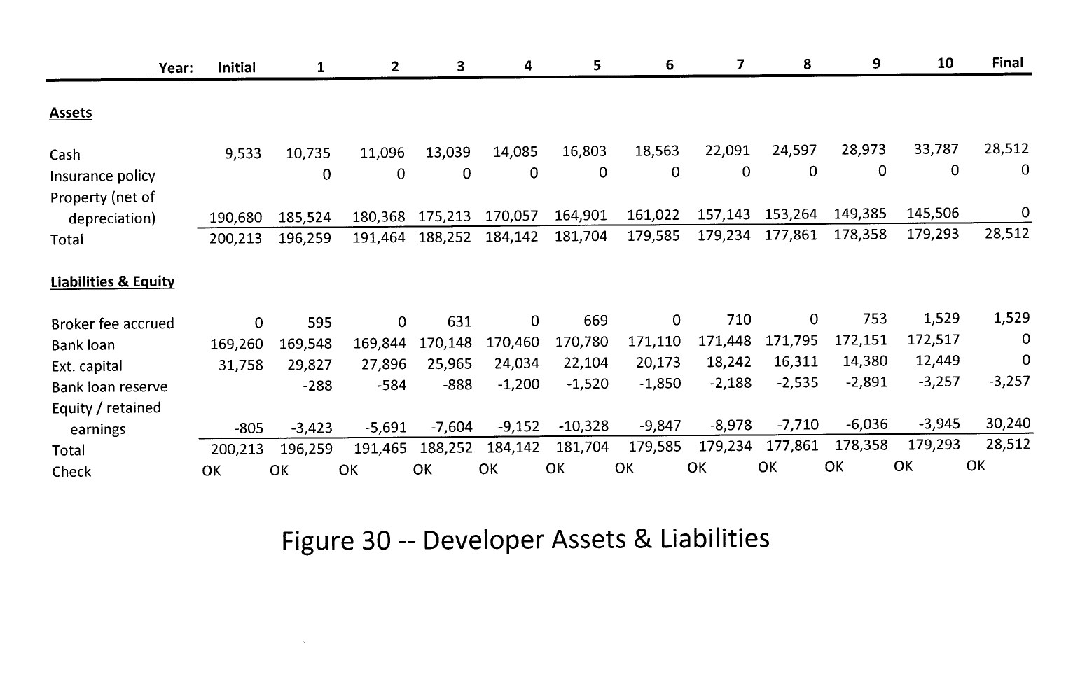

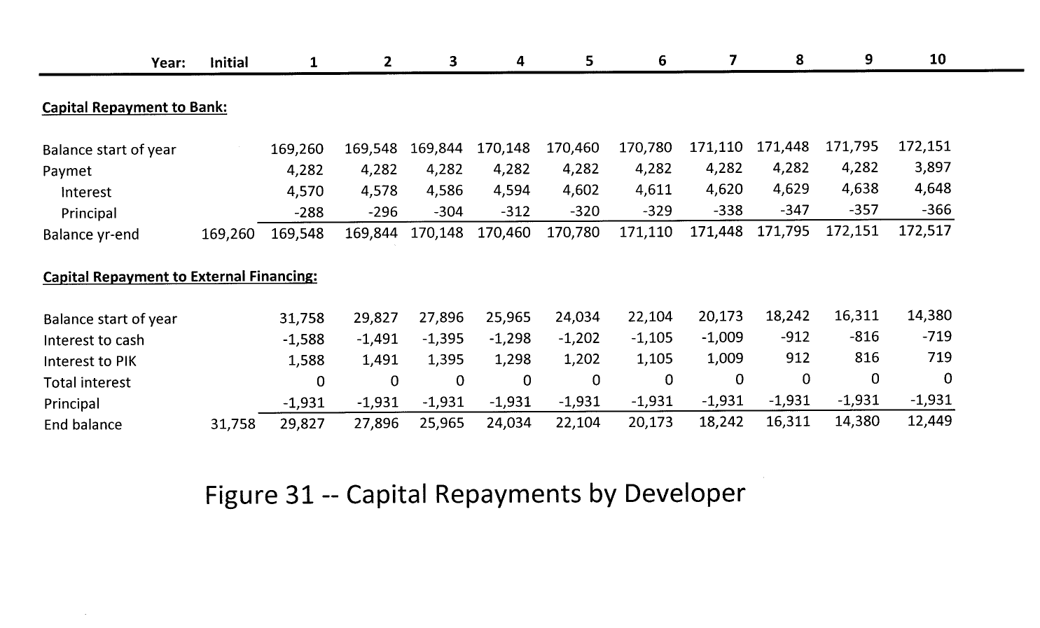

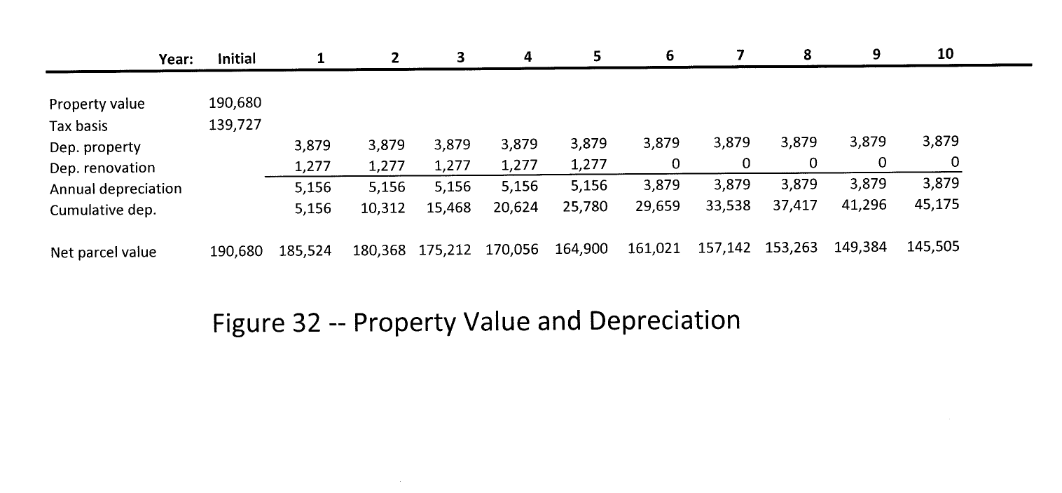

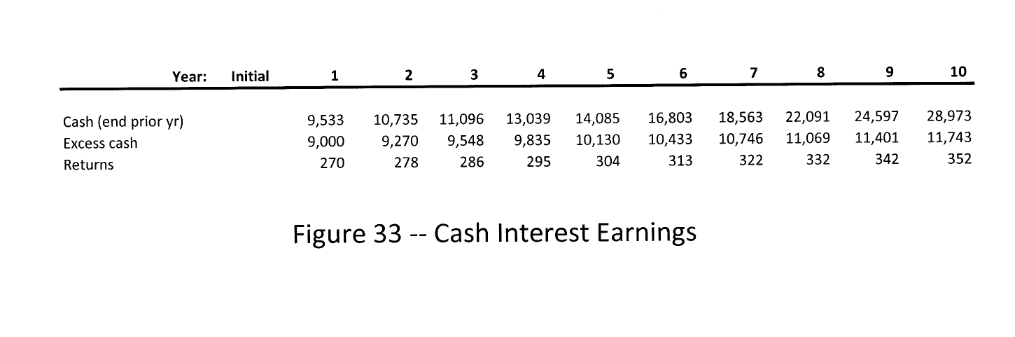

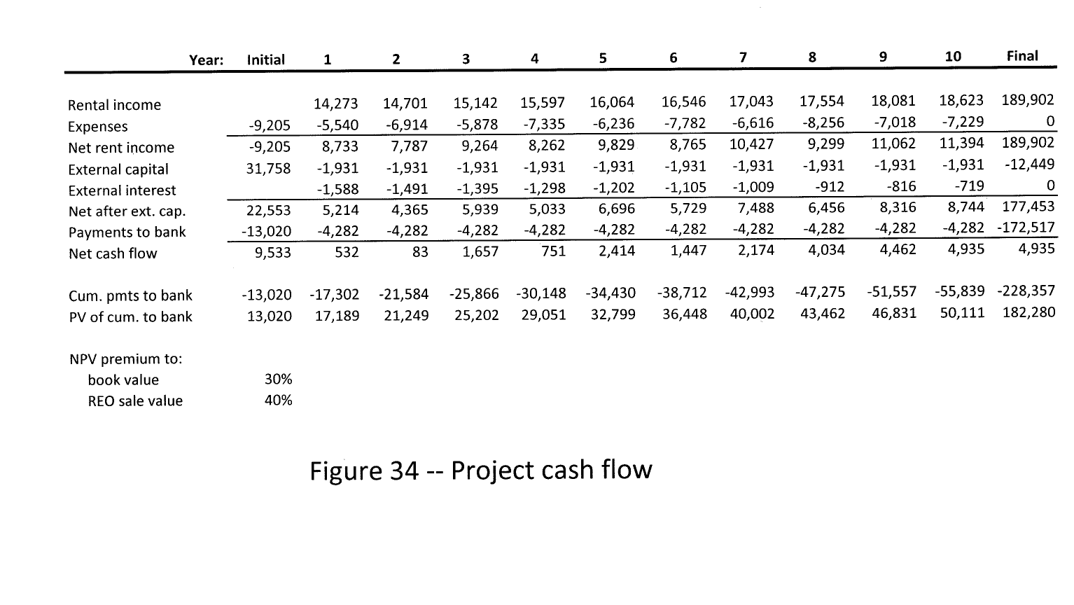

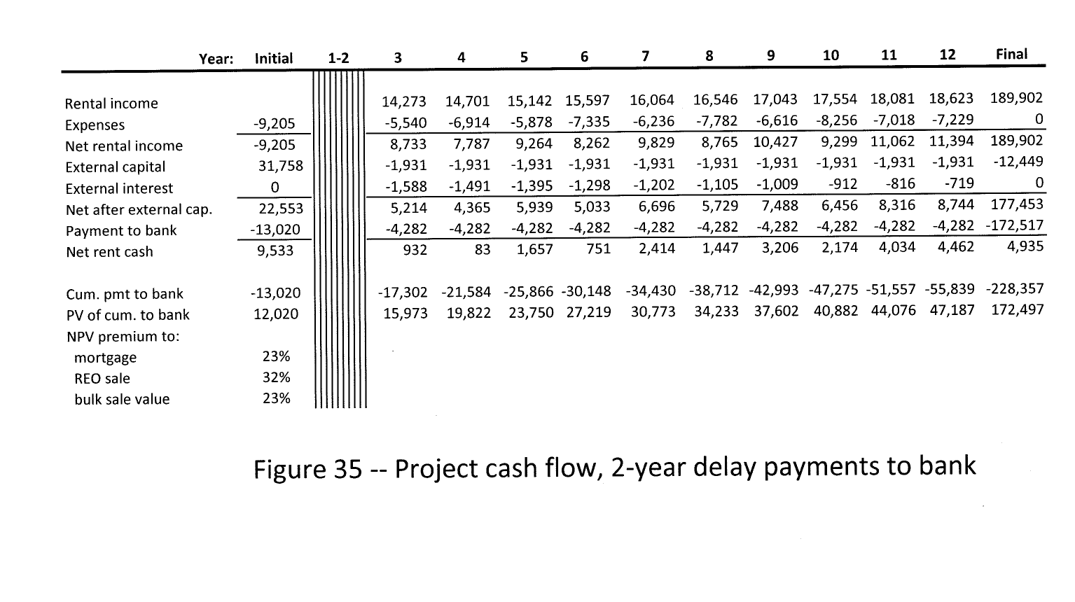

Example Four is illustrated in Tables 24 through 35 and FIGS. 28 through 35. FIGS. 28-35 are similar to FIGS. 5-12, respectively, but illustrate data for Example Four rather than Example One. Tables 24-28 provide financial projections for a sample REO among a sale of 10,000 REOs. FIGS. 28-33 illustrate projections for a transfer of 10,000 REOs and 25,000 mortgages. Table 29 and FIG. 34 further pertain to a sample REO; tables 30-34 pertain to 10,000 REOs; and Table 35 and FIG. 35 pertain to 25,000 mortgages.

As noted above, Example Four shows a portfolio of properties acquired at a 5.5% cap rate (still offering 40% above market). As with Example Three, this is a low cap rate for a portfolio. Although many=investors will not invest if the cap rate is below 6, but this example still provides substantial value to the acquirer (and its investors, if any). The acquirer may acquire properties at even lower cap rates if necessary.

In this example the acquirer pays the selling bank a 10% down payment, but the selling bank does not receive insurance on the annual or final payments. Such insurance could be provided in certain cases (even though it is not shown in this example). The selling bank would still have the right to receive insurance via a policy against losses for the overall portfolio, which would be factored into the pricing of value.

In some embodiments this policy will guarantee receipt of an amount equal to the value of the mortgage (or in the case of a REO, the original mortgage) even if such mortgage is substantially greater than the market value of the underlying property. In many cases the policy may provide substantial value above the mortgage, thus allowing for recovery of foreclosure costs, unpaid interest, and cost of capital. The seller (bank) may be able to release most mortgagors from their obligations without the need for a short sale, even if such borrowers are substantially under water. The policy may provide the seller with a definitive value for the assets as of the date of transfer; at minimum this would be equal to the value of the current mortgage. For REOs, the minimum value may be the value of the original mortgage, and for all assets the value may be as much as 70% above market-value for the applicable property.

TABLE 24
Property Assumptions (10,000 parcels)

| | |
|---|---|
| “As Renovated” value of property (“ARV”) | $158,788 |
| Value uplift for renovation | 7% |
| Mortgage value | $140,000 |
| Full market value | $140,000 |
| REO discount | 7% |
| REO value | $130,200 |

TABLE 25
Operational Assumptions

| | |
|---|---|
| Annual rent | $14,273 |
| Gross margin | $8,733 |
| Cap rate (ARV) | 5.5% |
| Price/rent ratio (at NRV) | 11.1xx |
| Rental yield (% of NRV) | 0 |
| Renovation cost (% of NRV) | 6% |
| Insurance policy premium (% of NRV) | 0 |
| insurance policy premium | 0 |
| Insurance policy amortization (years) | 10 |
| Initial monthly carrying cost (% of monthly expenses) | 52% |
| Annual rent increases | 3% |
| Inflation (rate at which cash would earn interest) | 3% |
| Operational expenses (% of annual rent) | 43% |
| Tax rate on income | 40% |
| Tax on final sale of properties in year 10 | 23% |
| Excess cash required | $9,000 |
| Management fees (years 2-5) | 0 |

TABLE 26
Transaction assumptions - acquirer to selling bank

| | |
|---|---|
| Percent of bank BV paid up-front | 10% |
| Percent of bank BV paid at end | 97% |
| Discount rate for time value of selling bank's payments | 2.7% |
| Interest rate for bank loan (same as TVM discount rate) | 2.7% |
| Seller bank rent participation | 30% |
| Seller bank rent participation in annual increases | 0 |
| NVP to selling bank of all payments over time | $182,280 |
| Implied premium to bank realizable value | 40% |
| Implied premium to bank if short or bulk sale | 30% |

TABLE 27
Transaction assumptions - acquirer to external capital

| | |
|---|---|
| Capital raise (senior loan) as % of ARV | 20% |
| Senior loan | $31,758 |
| Financing rate for external capital | 5% |
| External capital PIK | 0 |
| Percent of senior loan outstanding at end of transaction | 39.2% |
| Senior loan outstanding at end of transaction | $12,449 |

TABLE 28
Transaction assumptions - acquirer profit

| | |
|---|---|
| Final sale cap rate | 6% |
| Discount rate to aquirer for value calculations | 2% |
| PV to acquirer of final cash distribution | $23,389 |
| Actual cash payout to acquirer at year 10 | $28,512 |

TABLE 29
Property characteristics and operating assumptions

| Property characteristics | |
|---|---|
| Mortgage value | $140,000 |
| Full market value | 140,000 |
| REO sale value | 130,200 |
| Value after renovation | 158,788 |
| Key operating assumptions | |
| Property price/rent ratio | 11.1x |
| Operating cost as % of rental income | 43% |
| Selling bank cost of capital (for PV calc.) | 2.7% |
| External debt provider cost of capital | 5% |
| Final sales cap rate | 6% |

TABLE 30
Property Assumptions (10,000 parcels)

| | |
|---|---|
| “As Renovated” value of property (“ARV”) | $1,587,880,000 |
| Value uplift for renovation | 7% |
| Mortgage value | $1,400,000,000 |
| Full market value | $1,400,000,000 |
| REO discount | 7% |
| REO value | $1,302,000,000 |

TABLE 31
Operational Assumptions

| Price/rent ratio (at NRV) | 9x |
|---|---|
| Rental yield (% of NRV) | 11.1% |
| Renovation cost (% of NRV) | 6% |
| Insurance policy premium (% of NRV) | 0 |
| insurance policy premium | $4,000 |
| Insurance policy amortization (years) | 10 |
| Initial monthly carrying cost (% of monthly expenses) | 52% |
| Annual rent increases | 3% |
| Inflation (rate at which cash would earn interest) | 3% |
| Operational expenses (% of annual rent) | 43% |
| Tax rate on income | 40% |
| Tax on final sale of properties in year 10 | 23% |
| Excess cash required | $9,000 |
| Management fees (years 2-5) | 0 |

TABLE 32
Transaction assumptions - acquirer to selling bank

| | |
|---|---|
| Percent of bank BV paid up-front | 20% |
| Percent of bank BV paid at end | 97% |
| Discount rate for time value of selling bank's | 3% |
| payments | |
| Interest rate for bank loan (same as TVM discount | 3% |
| rate) | |
| Seller bank rent participation | 30% |
| Seller bank rent participation in annual increases | 0 |
| NVP to selling bank of all payments over time | $1,822,800,000* |
| *$182,280 per parcel | |
| Implied premium to bank realizable value | 40% |
| Implied premium to bank if short or bulk sale | 20% |

TABLE 33
Transaction assumptions - acquirer to external capital

| | |
|---|---|
| Capital raise (senior loan) as % of ARV | 35% |
| Senior loan | $555,758,000 |
| Financing rate for external capital | 5% |
| External capital PIK | 0 |
| Percent of senior loan outstanding at end of transactio | 39.2% |
| Senior loan outstanding at end of transaction | $217,864,572 |

TABLE 34
Transaction assumptions - acquirer profit

| | |
|---|---|
| Final sale cap rate | 6% |
| Discount rate to aquirer for value calculations | 2% |
| PV to acquirer of final cash distribution | $23,389 |
| Actual cash payout to acquirer at year 10 | $28,512 |

TABLE 35
Property characteristics and operating assumptions

| Property characteristics | |
|---|---|
| Mortgage value | $140,000 |
| Full market value | 140,000 |
| REO sale value | 130,200 |
| Value after renovation | 158,788 |
| Key operating assumptions | |
| Property price/rent ratio | 11.1x |
| Operating cost as % of rental income | 43% |
| Selling bank cost of capital (for PV calc.) | 2.7% |
| External debt provider cost of capital | 5% |
| Final sales cap rate | 6% |
| For 25,000 mortgages at $140,000: | |
| Mortgage value | $3,500,000,000 |
| REO value | $3,255,000,000 |
| Offer to bank | $$4,312,427,696 |
| For 30,000 mortgages: | |
| Mortgage value | $4,200,000,000 |
| REO value | $3,906,000,000 |
| Offer to bank | $5,174,913,235 |

### Example Five

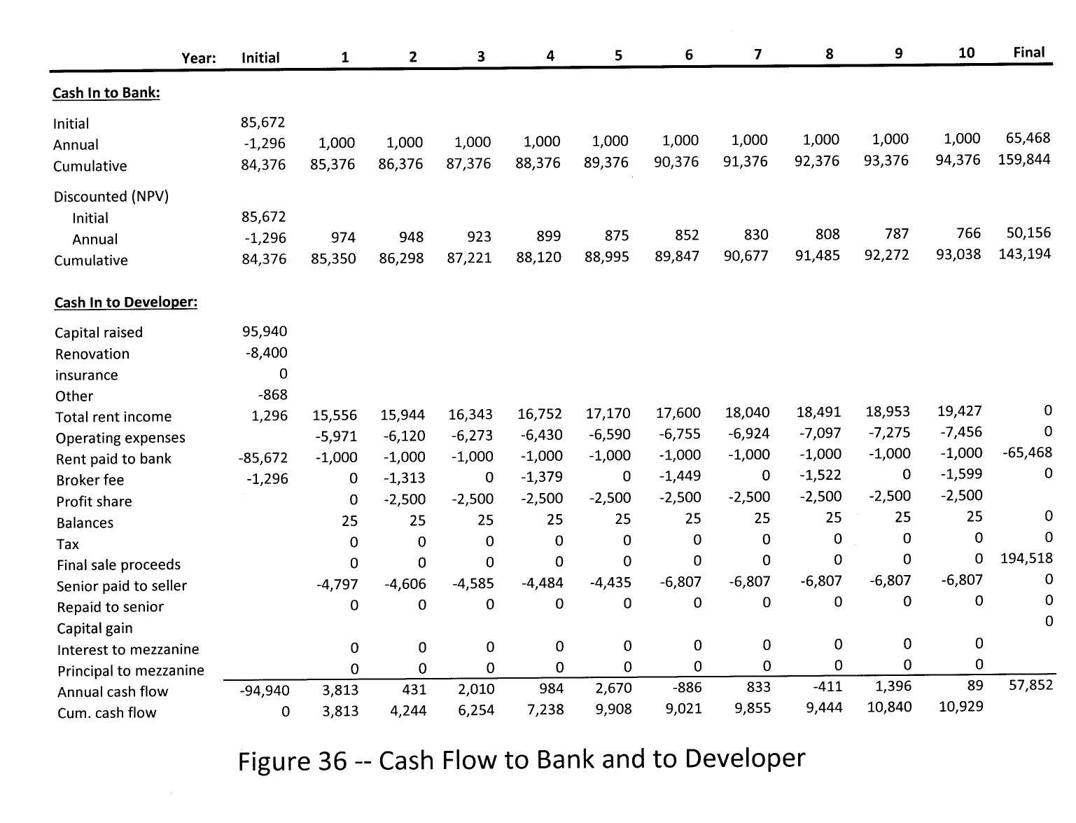

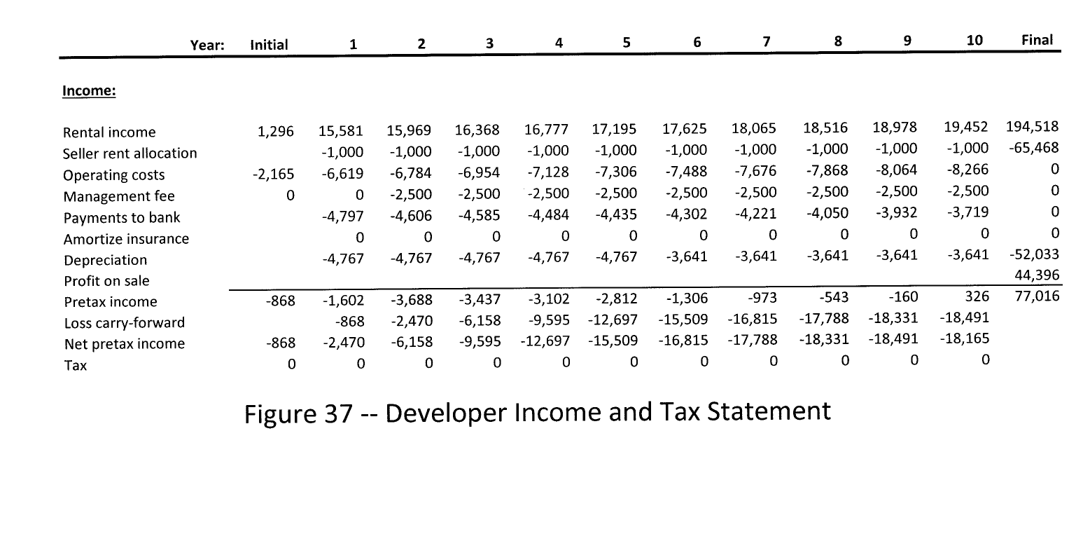

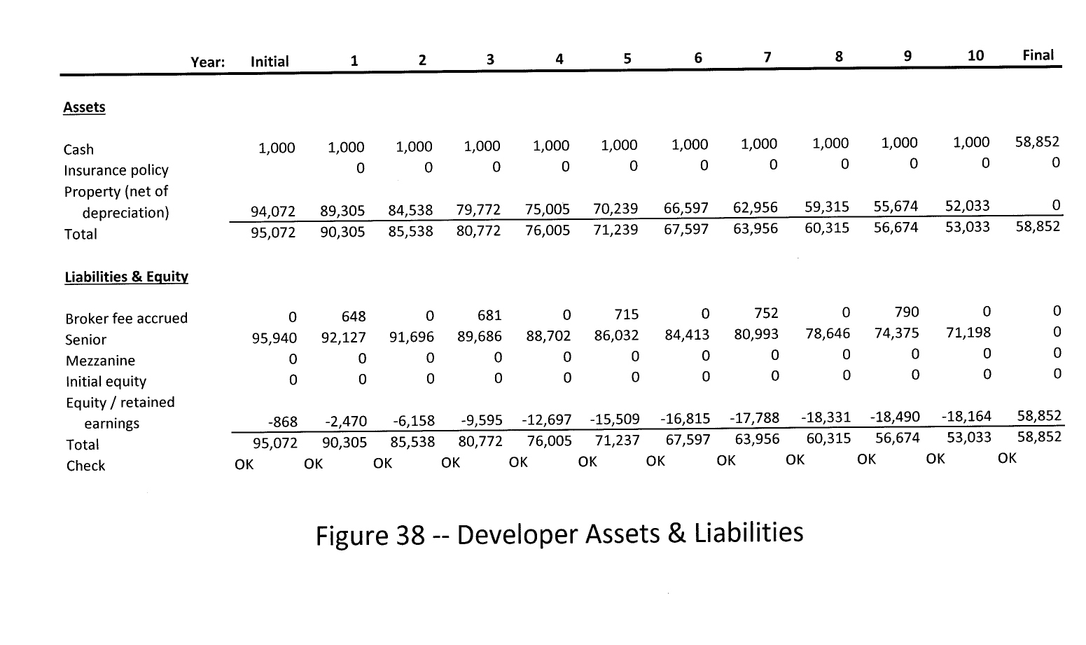

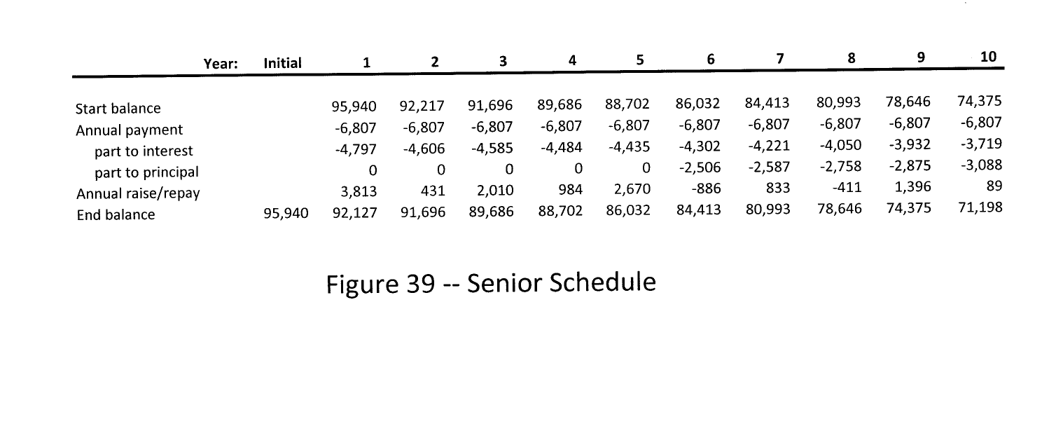

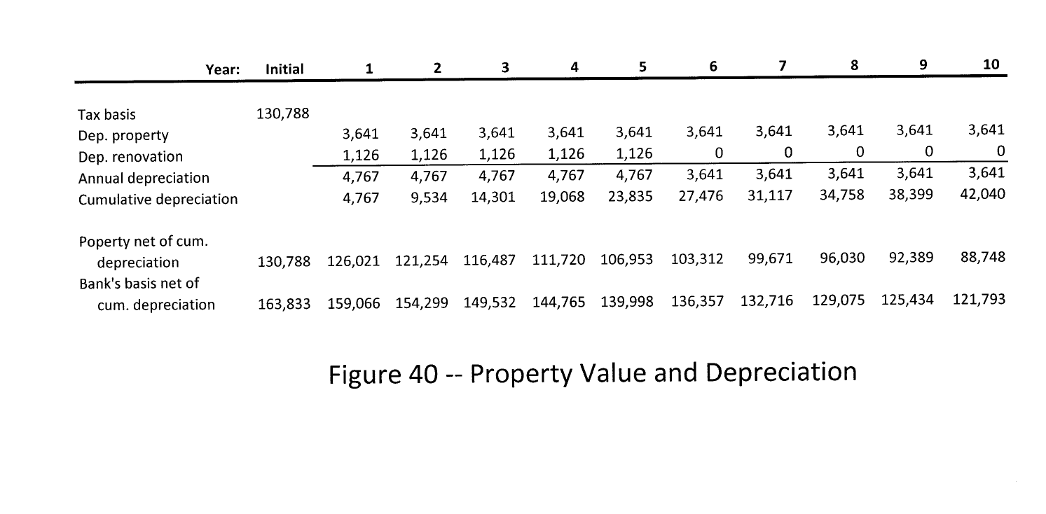

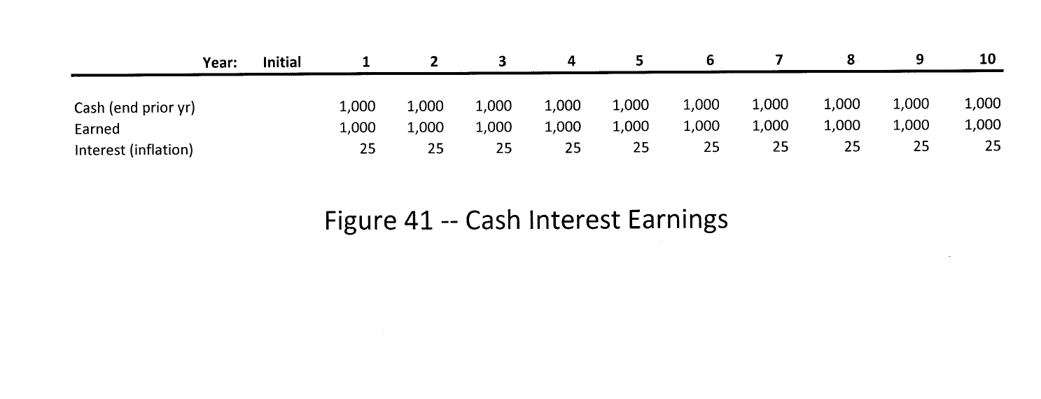

Example Five is illustrated in Tables 36 through 42 and FIGS. 36 through 41. FIGS. 36-41 are similar to FIGS. 5-10, respectively, but illustrate data for Example Five rather than Example One.

This example provides a profit share model. The acquirer and selling bank share in the profits derived through the real estate transaction process for the involved properties. This example is thus a type of partnership between an acquirer and an investor or bank for the purpose of buying REOs or mortgages from a third-party.

In this example it is assumed that the selling bank has a portfolio of REOs or mortgages, the face value of the mortgages being 30% above REO value (that is, the value it actually receives when selling). The acquirer partners with a third party and offers the selling bank the full value of the mortgages. This can be for any number of properties, from one to over 10,000. The mortgages are taken into account when they are converted to REOs.

The selling bank receives about $85,000 upfront with rest over time. Taking into account its discount rate (as supported by our methodology), the Selling Bank receives over $140 k—the value of its mortgage. The Selling Bank can receive a larger down-payment, higher annual payments, and/or a different final payment and will also have the opportunities for insurance (referenced above) if it wants them.

In this example, senior capital is required. Senior capital is provided by a partner of developer, the partner providing the entire $108K even though this is more than the partner would normally loan. For this reason, the partner is provided a substantial amount of profit ($46K) on top of repayment of the senior loan (some portion of which the partner can characterize as “mezzanine” if it prefers). In some cases the developer can also utilize mezzanine or equity financing or negotiate different terms with partners.

TABLE 36
Property Assumptions

| “As Renovated” value of property (“ARV”) | $140,000 |
|---|---|
| Renovation factor | 7% |
| Market value (non-REO) | $122,388 |
| Full market value | $140,000 |
| REO factor (reflects REO discount) | 90% |
| Value bank would get if sold as-si | $110,149 |
| Assumed value of mortgage | $143,149 |
| Monthly expenses | |
| HOA | $8 |
| Tax | $153 |
| Insurance | $75 |
| Management | $65 |
| Maintenance | $73 |
| Leasing agent | $54 |
| Vacancy | $78 |
| Corporate | $8 |
| Delinquency | $37 |
| Sub-total | $552 |
| Cost % | 43% |

TABLE 37
Operational Assumptions

| Price/rent ratio (at NRV) | 9x |
|---|---|
| Rental yield (% of NRV) | 11.1% |
| Renovation cost (% of NRV) | 6% |
| Insurance policy premium (% of NRV) | 0 |
| insurance policy premium | 0 |
| Insurance policy amortization (years) | 10 |
| Initial monthly carrying cost (% of monthly expenses) | 52% |
| Annual rent increases | 2.5% |
| Inflation (rate at which cash would earn interest) | 2.5% |
| Operational expenses (% of annual rent) | 42.5% |
| Tax rate on income | 40% |
| Tax on final sale of properties in year 10 | 0 |
| Excess cash required | $1,000 |
| Guaranteed acquirer buyout | $20,000 |
| Total acquirer | $31,570 |

TABLE 38
Transaction assumptions - acquirer to selling bank

| | |
|---|---|
| Percent of bank transaction value paid up-front | 70% |
| Discount rate for time value of selling bank's payments | 2.7% |
| Bank mortgage value) | 130% |
| Seller annual rent participation (PV terms) | $5,752 |
| Mortgage as percent of value | 0% |
| NVP to selling bank of all payments over time | $143,194 |
| Implied premium to foreclosure value | 30% |
| Premium to non-REO value | 17% |
| Spread mortgage value to parcel value | $33,045 |
| Bank capital recovery | $33,045 |
| Bank incremental net income | 0 |

TABLE 39
Transaction assumptions - acquirer to senior capital

| | |
|---|---|
| Senior loan | 68.53% |
| Senior loan | $95,940 |
| Interest rate | 5% |
| Amortization | 25 |
| Annual payment (interest only in years 1-5) | −$6,807 |
| Additional profit in year 10 | $46,282 |

TABLE 40
Transaction assumptions - acquirer to junior capital

| | |
|---|---|
| Costs | 0 |
| Junior (mezzanine) capital raised LTV at transaction value | 0 |
| Total mezzanine | 0 |
| Interest rate | 10% |
| External capital PIK | 0 |
| Percent of senior loan outstanding at end | 100% |
| Senior loan balance at end | $71,198 |

TABLE 41
Transaction assumptions - acquirer profit

| | |
|---|---|
| Final sale cap rate | 6% |
| Discount rate to aquirer for value calculations | 2% |
| PV to all equity of final cash distribution | 0 |
| PV of all payments | $93,038 |
| Actual total payments | $159,844 |

TABLE 42
Calculation of Sale of Property

| | |
|---|---|
| Fee | $194,518 |
| Book value | $52,033 |
| Final to bank | $65,468 |
| Taxable gain | $77,016 |
| Profit (bank and developer) | $57,852 |
| Developer profit share ($2,500/year for yrs 2-10) | $11,570 |
| PV at 5% | $23,688 |
| Developer total cash | $34,070 |
| Senior sale profit | $46,282 |
| PV at 2.7% | $35,457 |

Advantages of bulk sale real estate transaction processes in which insurance is provided to the selling bank to guarantee, for example, a final payment may include:

(1) The insurance component can provide the selling bank with a significant, up-front, guaranteed premium to the current market value of applicable properties. Although a stream of other payments to the bank for these properties can also take place, the up-front premium value is locked-in in compliance with GAAP.

(2) The insurance component can include a novel derivatives solution, allowing for varying levels of protection depending on the agreed stream of payments (that is, from full protection down to zero protection for the bank).

Further, because the transaction process can include renovating, leasing properties, and eventually selling them, the applicable mortgages are converted to REOs by the developer. The renovation, leasing, and sales process allows sufficient time to covert the properties to REOs, locks in value for such assets for the selling banks, and assists the non-performing borrowers for involved properties to become released from their obligations, with less damage to their credit, under their non-performing mortgages assigned to the developer in the real estate transaction process.

The renovation, leasing, and sale process also converts involved REOs into revenue producing assets with enhanced sale value. This can allow the developer to offer a stream of payments to selling banks and convert distressed REOs and non-performing mortgages into substantially higher value net present value sales to the developer.

In calculating a net present value, a discount rate is applied. If desired, the rate can be locked with interest rate swaps or by using various formulas to estimate costs of capital over time.

In engaging in the transaction process, the developer can provide other approaches for realizing value. For example, the developer can borrow from the selling bank, or the selling bank can issue the insurance components and procure the premium payments from the developer.

The transaction process also can include both mortgages and REOs, locking in improved net present value up-front for both types of assets. Any other type of asset can be included if desired in volumes that are typically unavailable to sellers currently. If rents are low or the condition of the properties is poor, the properties can still be included. These factors can impact the value and cost of insurance against loss, but such insurance can still be issued provided the bank is properly recognizing value on its balance sheet. The process can enhances value for all properties, and loss insurance can be issued in all cases.

The foregoing description provides instances, and is not itself limiting of the scope, applicability, or configuration of subject matter set forth in claims in this specification or as revised during prosecution. Changes may be made in the function and arrangement of steps and features discussed without departing from the scope of the disclosure. Various embodiments may omit, substitute, or add various procedures or components as appropriate.

For instance, certain aspects of the methods described may be performed in an order different from that described, and various steps may be added, omitted, or combined. Also, features described with respect to certain embodiments may be combined in other embodiments. Thus, while certain embodiments and details have been included herein for purposes of illustrating aspects of the instant disclosure, it will be apparent to those skilled in the art that various changes in systems, apparatus, and methods disclosed herein may be made without departing from the scope of the instant disclosure.

In this specification (including its claims), except as expressly stated expressly otherwise the term “developer” in connection with a developer obligation or action includes any developer sub-contractors or other third parties the developer may have fulfill the obligation or undertake the action. Thus, for example, an agreement reciting that the developer agrees to renovate embraces both: (i) the situation in which the developer may have the renovation done by a sub-contractor or other third party; and (ii) the situation in which the developer itself may be required do the renovation, whether of its own choosing or due to restraint on, or obligation of, the developer. Similarly, except as expressly stated otherwise a statement that the developer took an action, such as to renovate a parcel, includes action by the developer itself or action for the developer by a sub-contractor or other third party.

I claim:

1. A real estate transaction management process comprising: entering into a transfer agreement with a transaction institution to purchase a pool of real estate assets at a price above market value, the pool comprising a plurality of REO parcels and a plurality of delinquent loans, each loan secured by a mortgage encumbering a parcel; and, pursuant to the transfer agreement:
A. obtaining a plurality of the encumbered parcels by one or more of foreclosure, consent sales, and short sales;
B. renovating a plurality of the REO parcels and the obtained parcels;
C. leasing a plurality of the REO parcels and the obtained parcels to one or more third party lessees;
D. paying the transaction institution a leasing portion of lease revenue generated by said leasing;
E. selling a plurality of the REO parcels and the obtained parcels to one or more third party purchasers; and
F. paying the transaction institution a sales portion of sales revenue generated by said selling.

2. The real estate transaction management process of claim 1 wherein the transaction institution retains legal title to a plurality of the assets in the pool after entering into the transfer agreement until not later than any sale to a third party purchaser.

3. The real estate transaction management process of claim 1 further comprising obtaining a financing commitment at an interest rate lower than a predetermined future interest rate for loans to finance at least some sales of the REO parcels and the obtained parcels.

4. The real estate transaction management process of claim 3 wherein obtaining a financing commitment comprises obtaining the financing commitment from the transaction institution.

5. The real estate transaction management process of claim 1 further comprising providing insurance for the benefit of the transaction institution guaranteeing payment of a guaranteed portion of the sales revenue and lease revenue due the transaction institution.

6. The real estate transaction management process of claim 5 wherein providing insurance comprises obtaining the insurance from the transaction institution.

7. The real estate transaction management process of claim 1 wherein renovating comprises one or more of maintaining landscaping, painting exterior or interior surface, and repairing or replacing one or more of landscaping, plumbing, plumbing fixtures, electrical wiring, electrical fixtures, flooring, windows, doors, and appliances.

8. The real estate transaction management process of claim 1 wherein said leasing of a given parcel comprises leasing the given parcel for a fixed term and selling the given parcel at the end of that term.

9. A real estate transaction management process comprising: entering into a transfer agreement with a developer to sell a pool of real estate assets to the developer at a price above market value, the pool comprising a plurality of REO parcels and a plurality of delinquent loans, each loan secured by a mortgage encumbering a parcel; and, pursuant to the transfer agreement:
A. requiring the developer to obtain a plurality of the encumbered parcels by one or more of foreclosure, consensual sales, and short sales;
B. requiring the developer to renovate a plurality of the REO and obtained parcels;
C. requiring the developer to lease a plurality of the REO and obtained parcels to one or more third party lessees;
D. receiving a lease portion of lease revenue generated by said leasing;
E. requiring the developer to sell a plurality of the REO and obtained parcels to one or more third party purchasers; and
F. receiving a sales portion of sales revenue generated by said selling.

10. The real estate transaction management process of claim 9 further comprising retaining legal title to a plurality of the assets in the pool after entering into the transfer agreement until a time not later than any sale to a third party purchaser.

11. The real estate transaction management process of claim 9 further comprising providing a financing commitment at an interest rate lower than a predetermined future interest rate for loans to finance sales of the REO and obtained parcels.

12. The real estate transaction management process of claim 9 and further comprising providing insurance guaranteeing payment of the portion of the leasing and selling revenue to be received.

13. The real estate transaction management process of claim 9 wherein renovate comprises one or more of: maintain landscaping; paint exterior or interior surface; and repair or replace one or more of landscaping, plumbing, plumbing fixtures, electrical wiring, electrical fixtures, flooring, windows, doors, and appliances.

14. The real estate transaction management process of claim 9 wherein leasing a parcel comprises leasing the parcel for a fixed term and then selling the parcel to a third party.

15. A real estate transaction management process comprising generating a written agreement between a transaction institution and a developer, in which written agreement:
A. the transaction institution agrees to transfer to the developer a real estate asset pool, the pool including a plurality of REOs (real estate parcels owned) and a plurality of delinquent loans, each delinquent loan secured by a mortgage encumbering a parcel; and
B. the developer agrees to:
(1) obtain a plurality of the encumbered parcels by one or more of foreclosures, consensual sales, and short sales;
(2) renovate a plurality of the REOs and the obtained parcels; and
(3) pay to the transaction institution within a specified period of time after execution of the written agreement a purchase price above a market value of the asset pool, the market price determined as of a date specified by the written agreement.

16. The real estate transaction management process of claim 15 wherein the developer agrees that the transaction institution may retain legal title to a plurality of the RE assets in the pool until a time not later than any sale to a third party.

17. The real estate transaction management process of claim 15 wherein the developer agrees to lease to third parties a plurality of the REOs and obtained RE parcels, and to pay the transaction institution part of any resulting lease revenue.

18. The real estate transaction management process of claim 15 wherein the developer agrees to sell to third parties a plurality of the REOs and obtained RE parcels and to pay the transaction institution part of any resulting sales revenue.

19. The real estate transaction management process of claim 18 wherein one of the parties agrees to obtain a financing commitment at an interest rate lower than a predetermined future interest rate for loans to finance sales of parcels to third parties.

20. The real estate transaction management process of claim 15 wherein one of the parties agrees to procure insurance guaranteeing payment to the transaction institution of at least a portion of any funds due under the agreement.

21. A real estate transaction management process comprising causing execution of a written agreement between a developer and a transaction institution, in which written agreement the transaction institution commits to transfer to the developer a pool of real estate assets, including a plurality of notes secured by mortgages encumbering parcels of real estate, and in exchange the developer commits to:
A. pay the transaction institution a price substantially above present market value of the pool, within one or more years after the transaction institution transfers the pool to the developer;
B. acquire title to a plurality of the encumbered parcels by foreclosure, consensual sales, and short sales and thereby add those parcels to the pool; and
C. improve, including by physically renovating, a plurality of the assets.

22. The real estate transaction management process of claim 21 further comprising procuring insurance guaranteeing payment to the transaction institution of at least a portion of the price.

23. The real estate transaction management process of claim 22 wherein at least a portion of the insurance is provided by the transaction institution.

24. The real estate transaction management process of claim 21 and further comprising obtaining a financing commitment at an interest rate lower than a predetermined future interest rate for loans to finance future sales of individual ones of the assets in the pool.

25. The real estate transaction management process of claim 24 wherein obtaining a financing commitment comprises interest rate swapping.

26. The process of claim 24 wherein at least a portion of the financing commitment is provided by the transaction institution.

27. The real estate transaction management process of claim 21 wherein the price includes payments from time to time to the transaction institution of at least a portion of revenue received by the developer from rental and sale of pool assets.

28. The real estate transaction management process of claim 21 wherein substantially above present market value means at least 20% above market value determined as of a date specified in the written agreement.

29. The real estate transaction management process of claim 21 wherein substantially above present market value means at least 40% above market value determined as of a date specified in the written agreement.
